(19) United States
(12) Patent Application Publication
(10) Pub. No.: US 2026/0110340 A1
(43) Pub. Date: Apr. 23, 2026

(54) CLUTCH APPARATUS

(71) Applicant: Kabushiki Kaisha F.C.C., Hamamatsu-shi (JP)

(72) Inventor: Masataka MURAI, Hamamatsu-shi (JP)

(21) Appl. No.: 19/344,984

(22) Filed: Sep. 30, 2025

Related U.S. Application Data
(63) Continuation of application No. PCT/JP2025/016071, filed on Apr. 25, 2025.

(30) Foreign Application Priority Data
Oct. 23, 2024 (JP) 2024-186835

(51) Int. Cl. F16D 13/70; F16D 23/12

(52) U.S. Cl. CPC F16D 13/70; F16D 23/12; F16D 2023/123

(57) ABSTRACT

In a clutch apparatus, a clutch center includes center-side fitting teeth arranged in a circumferential direction, and center-side spline grooves each provided between adjacent ones of the center-side fitting teeth, and a pressure plate includes pressure-side fitting teeth arranged in the circumferential direction, and pressure-side spline grooves each provided between adjacent ones of the pressure-side fitting teeth. An end of the center-side fitting teeth facing in a second direction is provided with center-side protrusions extending in the second direction. During at least part of a half-clutch state, at least portions of the center-side protrusions overlap with the pressure-side spline grooves when viewed in a radial direction of an output shaft.

### CROSS REFERENCE TO RELATED APPLICATIONS

This application claims the benefit of priority to Japanese Patent Application No. 2024-186835 filed on Oct. 23, 2024 and is a Continuation Application of PCT Application No. PCT/JP2025/016071 filed on Apr. 25, 2025. The entire contents of each application are hereby incorporated herein by reference.

### BACKGROUND OF THE INVENTION

### 1. Field of the Invention

The present invention relates to clutch apparatuses.

### 2. Description of Related Art

As is known in the art, vehicles, such as motorcycles, include clutch apparatuses. JP 2018-204655 A, for example, discloses a clutch apparatus including a clutch center holding some of output-side rotary plates, and a pressure plate movable toward and away from the clutch center and holding the remaining one or more output-side rotary plates. The clutch center and the pressure plate each include an outer peripheral wall having an annular shape, and fitting teeth protruding radially outward from an outer peripheral surface of the outer peripheral wall. The output-side rotary plates are held by the fitting teeth. The output-side rotary plates are configured to be movable in an axial direction along the fitting teeth of the clutch center and the fitting teeth of the pressure plate.

### SUMMARY OF THE INVENTION

In the clutch apparatus described in JP 2018-204655 A, the fitting teeth of the clutch center include protruding teeth protruding toward the pressure plate. For example, when a clutch operation lever is not being operated, the protruding teeth overlap with the fitting teeth of the pressure plate as viewed in a radial direction. Upon movement of the pressure plate away from the clutch center, some of the output-side rotary plates held by the fitting teeth may unfortunately be disengaged from the fitting teeth depending on the shapes of the protruding teeth.

Example embodiments of the present invention provide clutch apparatuses each of which is able to prevent output-side rotary plates from being disengaged from fitting teeth that are included in a clutch center and a pressure plate and that hold the output-side rotary plates.

A clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft, and a pressure plate movable toward or away from the clutch center and configured to hold a remaining one or more of the output-side rotary plates and to push the input-side rotary plates and the output-side rotary plates. The clutch center includes a center-side outer peripheral wall having an annular shape extending in a movement direction, where a direction in which the pressure plate is movable toward and away from the clutch center is the movement direction, center-side fitting teeth holding the output-side rotary plates, protruding outward in a radial direction from an outer peripheral surface of the center-side outer peripheral wall, and arranged in a circumferential direction, and center-side spline grooves each provided between adjacent ones of the center-side fitting teeth. The pressure plate includes a pressure-side outer peripheral wall having an annular shape extending in the movement direction, pressure-side fitting teeth holding the output-side rotary plates, protruding outward in the radial direction from an outer peripheral surface of the pressure-side outer peripheral wall, and arranged in the circumferential direction, and pressure-side spline grooves each provided between adjacent ones of the pressure-side fitting teeth. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. Where a direction in which the pressure plate is movable toward the clutch center is a first direction and a direction in which the pressure plate is movable away from the clutch center is a second direction, an end of the center-side fitting teeth facing in the second direction is provided with center-side protrusions extending in the second direction. During at least part of a half-clutch state, at least portions of the center-side protrusions overlap with the pressure-side spline grooves when viewed in the radial direction of the output shaft.

In a clutch apparatus according to an example embodiment of the present invention, during at least part of the half-clutch state, at least portions of the center-side protrusions overlap with the pressure-side spline grooves when viewed in the radial direction of the output shaft. During at least part of the half-clutch state, this example embodiment is able to prevent the output-side rotary plates, which are held by the pressure-side fitting teeth and the center-side fitting teeth, from being disengaged from the pressure-side fitting teeth and the center-side fitting teeth.

Another clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally driven together with the output shaft, and a pressure plate movable toward or away and configured to hold a remaining one or more output-side rotary plates and to push the input-side rotary plates and the output-side rotary plates. The clutch center includes a center-side outer peripheral wall having an annular shape extending in a movement direction, where a direction in which the pressure plate is movable toward and away from the clutch center is the movement direction, center-side fitting teeth holding the output-side rotary plates, protruding outward in a radial direction from an outer peripheral surface of the center-side outer peripheral wall, and arranged in a circumferential direction, and center-side spline grooves each provided between adjacent ones of the center-side fitting teeth. The pressure plate includes a pressure-side outer peripheral wall having an annular shape extending in the movement direction, pressure-side fitting teeth holding the output-side rotary plates, protruding outward in the radial direction from an outer peripheral surface of the pressure-side outer peripheral wall, and arranged in the circumferential direction, and pressure-side spline grooves each provided between adjacent ones of the pressure-side fitting teeth. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. Where a direction in which the pressure plate is movable toward the clutch center is a first direction and a direction in which the pressure plate is movable away from the clutch center is a second direction, an end of the pressure-side fitting teeth facing in the first direction is provided with pressure-side protrusions extending in the first direction. During at least part of a half-clutch state, at least portions of the pressure-side protrusions overlap with the center-side spline grooves when viewed in the radial direction of the output shaft.

In this another clutch apparatus according to an example embodiment of the present invention, during at least part of the half-clutch state, at least portions of the pressure-side protrusions overlap with the center-side spline grooves when viewed in the radial direction of the output shaft. During at least part of the half-clutch state, this example embodiment is able to prevent the output-side rotary plates, which are held by the pressure-side fitting teeth and the center-side fitting teeth, from being disengaged from the pressure-side fitting teeth and the center-side fitting teeth.

Still another clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft, and a pressure plate movable toward or away from the clutch center and configured to hold a remaining one or more of the output-side rotary plates and to push the input-side rotary plates and the output-side rotary plates. The clutch center includes a center-side outer peripheral wall having an annular shape extending in a movement direction, where a direction in which the pressure plate is movable toward and away from the clutch center is the movement direction, and center-side fitting teeth holding the output-side rotary plates, protruding outward in a radial direction from an outer peripheral surface of the center-side outer peripheral wall, and arranged in a circumferential direction, center-side spline grooves each provided between adjacent ones of the center-side fitting teeth, and center-side cam portions including center-side assist cam surfaces to, upon rotation of the clutch center relative to the pressure plate, produce a force in a direction from the pressure plate toward the clutch center to increase a pushing force for the input-side rotary plates and the output-side rotary plates. The pressure plate includes a pressure-side outer peripheral wall having an annular shape extending in the movement direction, pressure-side fitting teeth holding the output-side rotary plates, protruding outward in the radial direction from an outer peripheral surface of the pressure-side outer peripheral wall, and arranged in the circumferential direction, pressure-side spline grooves each provided between adjacent ones of the pressure-side fitting teeth, and pressure-side cam portions including pressure-side assist cam surfaces to, upon rotation of the pressure plate relative to the clutch center, produce a force in the direction from the pressure plate toward the clutch center to increase the pushing force for the input-side rotary plates and the output-side rotary plates. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. Where a direction in which the pressure plate is movable toward the clutch center is a first direction and a direction in which the pressure plate is movable away from the clutch center is a second direction, an end of the center-side fitting teeth facing in the second direction is provided with center-side protrusions extending in the second direction. With the center-side assist cam surfaces and the pressure-side assist cam surfaces in contact with each other, at least portions of the center-side protrusions overlap with the pressure-side spline grooves when viewed in the radial direction of the output shaft.

In this still another clutch apparatus according to an example embodiment of the present invention, with the center-side assist cam surfaces and the pressure-side assist cam surfaces in contact with each other, at least portions of the center-side protrusions overlap with the pressure-side spline grooves when viewed in the radial direction of the output shaft. With the center-side assist cam surfaces and the pressure-side assist cam surfaces in contact with each other, this example embodiment is able to prevent the output-side rotary plates, which are held by the pressure-side fitting teeth and the center-side fitting teeth, from being disengaged from the pressure-side fitting teeth and the center-side fitting teeth.

Yet another clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft, and a pressure plate movable toward or away from the clutch center and configured to hold a remaining one or more of the output-side rotary plates and to push the input-side rotary plates and the output-side rotary plates. The clutch center includes a center-side outer peripheral wall having an annular shape extending in a movement direction, where a direction in which the pressure plate is movable toward and away from the clutch center is the movement direction, center-side fitting teeth holding the output-side rotary plates, protruding outward in a radial direction from an outer peripheral surface of the center-side outer peripheral wall, and arranged in a circumferential direction, center-side spline grooves each provided between adjacent ones of the center-side fitting teeth, and center-side cam portions including center-side assist cam surfaces to, upon rotation of the clutch center relative to the pressure plate, produce a force in a direction from the pressure plate toward the clutch center to increase a pushing force for the input-side rotary plates and the output-side rotary plates. The pressure plate includes a pressure-side outer peripheral wall having an annular shape extending in the movement direction, pressure-side fitting teeth holding the output-side rotary plates, protruding outward in the radial direction from an outer peripheral surface of the pressure-side outer peripheral wall, and arranged in the circumferential direction, pressure-side spline grooves each provided between adjacent ones of the pressure-side fitting teeth, and pressure-side cam portions including pressure-side assist cam surfaces to, upon rotation of the pressure plate relative to the clutch center, produce a force in the direction from the pressure plate toward the clutch center to increase the pushing force for the input-side rotary plates and the output-side rotary plates. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. Where a direction in which the pressure plate is movable toward the clutch center is a first direction and a direction in which the pressure plate is movable away from the clutch center is a second direction, an end of the pressure-side fitting teeth facing in the first direction is provided with pressure-side protrusions extending in the first direction. With the center-side assist cam surfaces and the pressure-side assist cam surfaces in contact with each other, at least portions of the pressure-side protrusions overlap with the center-side spline grooves when viewed in the radial direction of the output shaft.

In this yet another clutch apparatus according to an example embodiment of the present invention, with the center-side assist cam surfaces and the pressure-side assist cam surfaces in contact with each other, at least portions of the pressure-side protrusions overlap with the center-side spline grooves when viewed in the radial direction of the output shaft. With the center-side assist cam surfaces and the pressure-side assist cam surfaces in contact with each other, this example embodiment is able to prevent the output-side rotary plates, which are held by the pressure-side fitting teeth and the center-side fitting teeth, from being disengaged from the pressure-side fitting teeth and the center-side fitting teeth.

Still yet another clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft, and a pressure plate movable toward or away from the clutch center and configured to hold a remaining one or more of the output-side rotary plates and to push the input-side rotary plates and the output-side rotary plates, and a stopper plate secured to the pressure plate to come into contact with the clutch center and to prevent the pressure plate from moving away from the clutch center in a second direction by a predetermined distance or more, where a direction in which the pressure plate is movable toward and away from the clutch center is a movement direction, a direction in which the pressure plate is movable toward the clutch center is a first direction, and a direction in which the pressure plate is movable away from the clutch center is the second direction. The clutch center includes a center-side outer peripheral wall having an annular shape extending in the movement direction, and center-side fitting teeth holding the output-side rotary plates, protruding outward in a radial direction from an outer peripheral surface of the center-side outer peripheral wall, and arranged in a circumferential direction. The pressure plate includes a pressure-side outer peripheral wall having an annular shape extending in the movement direction, and pressure-side fitting teeth holding the output-side rotary plates, protruding outward in the radial direction from an outer peripheral surface of the pressure-side outer peripheral wall, and arranged in the circumferential direction. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. An end of the center-side fitting teeth facing in the second direction is provided with center-side protrusions extending in the second direction. With the clutch center and the stopper plate in contact with each other, a clearance is created between each of the center-side protrusions and the pressure plate in the movement direction when viewed in the radial direction of the output shaft. A length of the clearance in the movement direction is shorter than a length of each of the output-side rotary plates in the movement direction.

In this still yet another clutch apparatus according to an example embodiment of the present invention, with the clutch center and the stopper plate in contact with each other, the clearance is created between each center-side protrusion and the pressure plate in the movement direction when viewed in the radial direction of the output shaft, and the length of each clearance in the movement direction is shorter than the length of each output-side rotary plate in the movement direction. This example embodiment is able to prevent the output-side rotary plates, which are held by the pressure-side fitting teeth and the center-side fitting teeth, from being disengaged from the pressure-side fitting teeth and the center-side fitting teeth.

Another clutch apparatus according to an example embodiment of the present invention is a clutch apparatus to transmit a rotational driving force of an input shaft to an output shaft or cut off the rotational driving force. The clutch apparatus includes a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft, and a pressure plate movable toward or away from the clutch center and configured to hold a remaining one or more of the output-side rotary plates and to push the input-side rotary plates and the output-side rotary plates, and a stopper plate secured to the clutch center to come into contact with the pressure plate and to prevent the pressure plate from moving away from the clutch center in a second direction by a predetermined distance or more, where a direction in which the pressure plate is movable toward and away from the clutch center is a movement direction, a direction in which the pressure plate is movable toward the clutch center is a first direction, and a direction in which the pressure plate is movables away from the clutch center is the second direction. The clutch center includes a center-side outer peripheral wall having an annular shape extending in the movement direction, and center-side fitting teeth holding the output-side rotary plates, protruding outward in a radial direction from an outer peripheral surface of the center-side outer peripheral wall, and arranged in a circumferential direction. The pressure plate includes a pressure-side outer peripheral wall having an annular shape extending in the movement direction, and pressure-side fitting teeth holding the output-side rotary plates, protruding outward in the radial direction from an outer peripheral surface of the pressure-side outer peripheral wall, and arranged in the circumferential direction. When viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction. An end of the pressure-side fitting teeth facing in the first direction is provided with pressure-side protrusions extending in the first direction. With the pressure plate and the stopper plate in contact with each other, a clearance is created between each of the pressure-side protrusions and the clutch center in the movement direction when viewed in the radial direction of the output shaft. A length of the clearance in the movement direction is shorter than a length of each of the output-side rotary plates in the movement direction.

In this another clutch apparatus according to an example embodiment of the present invention, with the pressure plate and the stopper plate in contact with each other, the clearance is created between each pressure-side protrusion and the clutch center in the movement direction when viewed in the radial direction of the output shaft, and the length of each clearance in the movement direction is shorter than the length of each output-side rotary plate in the movement direction. This example embodiment is able to prevent the output-side rotary plates, which are held by the pressure-side fitting teeth and the center-side fitting teeth, from being disengaged from the pressure-side fitting teeth and the center-side fitting teeth.

Example embodiments of the present invention provide clutch apparatuses each of which prevents output-side rotary plates from being disengaged from fitting teeth that are included in a clutch center and a pressure plate and that hold the output-side rotary plates.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view of a clutch apparatus according to a first example embodiment of the present invention.

FIG. 2 is a perspective view of a clutch center according to the first example embodiment of the present invention.

FIG. 3 is a plan view of the clutch center according to the first example embodiment of the present invention.

FIG. 4 is a perspective view of the clutch center according to the first example embodiment of the present invention.

FIG. 5 is a plan view of the clutch center according to the first example embodiment of the present invention.

FIG. 6 is a perspective view of a pressure plate according to the first example embodiment of the present invention.

FIG. 7 is a plan view of the pressure plate according to the first example embodiment of the present invention.

FIG. 8 is a perspective view of the pressure plate according to the first example embodiment of the present invention.

FIG. 9 is a plan view of the pressure plate according to the first example embodiment of the present invention.

FIG. 10A is a schematic diagram illustrating actions of a center-side assist cam surface and a pressure-side assist cam surface.

FIG. 10B is a schematic diagram illustrating actions of a center-side slipper cam surface and a pressure-side slipper cam surface.

FIG. 11 is a schematic diagram illustrating a positional relationship between a center-side annular portion and a pressure-side annular portion as viewed in an axial direction of an output shaft.

FIG. 12 is a plan view of the clutch center and the pressure plate when viewed in the axial direction of the output shaft, with center-side assist cam surfaces and pressure-side assist cam surfaces in contact with each other.

FIG. 13 is a side view of the clutch center and the pressure plate, illustrating a portion of one center-side protrusion and an associated pressure-side spline groove overlapping with each other when viewed in a radial direction of the output shaft.

FIG. 14 is a side view of the clutch center and the pressure plate, illustrating a clearance created between one center-side protrusion and the pressure plate when viewed in the radial direction of the output shaft.

FIG. 15 is a side view of an outermost output-side rotary plate and one center-side protrusion, illustrating a relationship therebetween when viewed in the radial direction of the output shaft.

FIG. 16 is a side view of the clutch center and the pressure plate, illustrating a portion of one pressure-side protrusion and an associated center-side spline groove overlapping with each other when viewed in the radial direction of the output shaft.

FIG. 17 is a cross-sectional view of a clutch apparatus according to a second example embodiment of the present invention.

FIG. 18 is a perspective view of a clutch center according to the second example embodiment of the present invention.

FIG. 19 is a plan view of the clutch center according to the second example embodiment of the present invention.

FIG. 20 is a perspective view of the clutch center according to the second example embodiment of the present invention.

FIG. 21 is a plan view of the clutch center according to the second example embodiment of the present invention.

FIG. 22 is a perspective view of a pressure plate according to the second example embodiment of the present invention.

FIG. 23 is a plan view of the pressure plate according to the second example embodiment of the present invention.

FIG. 24 is a perspective view of the pressure plate according to the second example embodiment of the present invention.

FIG. 25 is a plan view of the pressure plate according to the second example embodiment of the present invention.

FIG. 26 is a schematic diagram illustrating a positional relationship between a center-side annular portion and a pressure-side annular portion as viewed in an axial direction of an output shaft.

FIG. 27 is a schematic diagram illustrating a positional relationship between center-side fitting teeth and pressure-side fitting teeth when viewed in the axial direction of the output shaft.

FIG. 28 is a schematic diagram illustrating a positional relationship between the center-side fitting teeth and the pressure-side fitting teeth when viewed in the axial direction of the output shaft.

FIG. 29 is a schematic diagram illustrating a positional relationship between the center-side fitting teeth and the pressure-side fitting teeth when viewed in the axial direction of the output shaft.

FIG. 30 is a table illustrating positional relationships between the center-side fitting teeth and the pressure-side fitting teeth when viewed in the axial direction of the output shaft.

FIG. 31 is a side view of the clutch center and the pressure plate, illustrating a central line of one center-side spline groove and a central line of an associated pressure-side spline groove being collinear when viewed in a radial direction of the output shaft.

FIG. 32 is a plan view of the clutch center and the pressure plate when viewed in the axial direction of the output shaft, with center-side assist cam surfaces and pressure-side assist cam surfaces in contact with each other.

FIG. 33 is a side view of the clutch center and the pressure plate, illustrating a portion of one pressure-side protrusion and the associated center-side spline groove overlapping with each other when viewed in the radial direction of the output shaft.

FIG. 34 is a side view of the clutch center and the pressure plate, illustrating a clearance created between one pressure-side protrusion and the clutch center when viewed in the radial direction of the output shaft.

FIG. 35 is a side view of an outermost output-side rotary plate and one pressure-side protrusion, illustrating a relationship therebetween when viewed in the radial direction of the output shaft.

FIG. 36 is a side view of the clutch center and the pressure plate, illustrating a portion of one center-side protrusion and the associated pressure-side spline groove overlapping with each other when viewed in the radial direction of the output shaft.

### DETAILED DESCRIPTION OF THE EXAMPLE EMBODIMENTS

Example embodiments of clutch apparatuses according to the present invention will be described below with reference to the drawings. The example embodiments described herein are naturally not intended to limit the present invention in any way. Components and elements similar in function are identified by the same reference signs and, where appropriate, their description may be omitted or provided briefly to avoid redundancy.

### First Example Embodiment

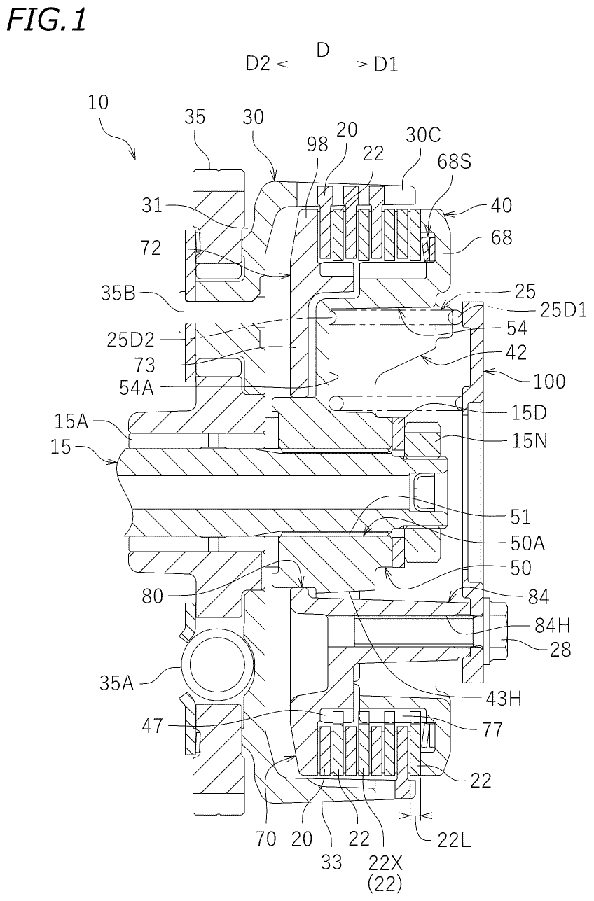

FIG. 1 is a cross-sectional view of a clutch apparatus 10 according to a first example embodiment. The clutch apparatus 10 is installed, for example, on a vehicle, such as a motorcycle. The clutch apparatus 10 is, for example, an apparatus to transmit a rotational driving force of an input shaft (e.g., a crankshaft), which is included in a power source (such as an engine) mounted on a motorcycle, to an output shaft 15 or cut off the rotational driving force. The clutch apparatus 10 is an apparatus to transmit the rotational driving force of the input shaft to a driving wheel (e.g., a rear wheel) through the output shaft 15 or cut off the rotational driving force. The clutch apparatus 10 is disposed between the engine and a transmission.

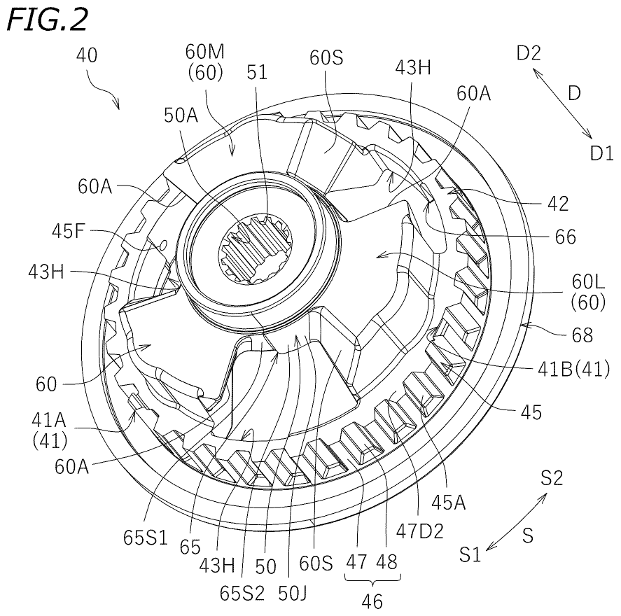

In the following description, a direction in which a pressure plate 70 of the clutch apparatus 10 moves toward and away from a clutch center 40 will be referred to as a “direction D”, a direction in which the pressure plate 70 moves toward the clutch center 40 will be referred to as a “first direction D1”, and a direction in which the pressure plate 70 moves away from the clutch center 40 will be referred to as a “second direction D2”. The direction D is an example of a movement direction. A circumferential direction of the clutch center 40 and the pressure plate 70 will be referred to as a “circumferential direction S”. A direction from a first side toward a second side in the circumferential direction S will be referred to as a “first circumferential direction S1” (see FIG. 2). A direction from the second side toward the first side in the circumferential direction S will be referred to as a “second circumferential direction S2” (see FIG. 2). In the present example embodiment, an axial direction of the output shaft 15, an axial direction of a clutch housing 30, an axial direction of the clutch center 40, and an axial direction of the pressure plate 70 each correspond to the direction D. The pressure plate 70 and the clutch center 40 rotate in the first circumferential direction S1. These directions, however, are defined solely for descriptive convenience and do not limit in any way how the clutch apparatus 10 may be installed or how example embodiments of the present invention may be practiced.

As illustrated in FIG. 1, the clutch apparatus 10 includes the output shaft 15, input-side rotary plates 20, output-side rotary plates 22, the clutch housing 30, the clutch center 40, the pressure plate 70, and a stopper plate 100.

As illustrated in FIG. 1, the output shaft 15 is a hollow shaft body. A first end portion of the output shaft 15 supports an input gear 35 and the clutch housing 30 (which will be described below) through a bearing 15A such that the input gear 35 and the clutch housing 30 are rotatable. The output shaft 15 supports the clutch center 40 through a washer 15D and a nut 15N such that the clutch center 40 is secured to the output shaft 15. In other words, the output shaft 15 rotates together with the clutch center 40. A second end portion of the output shaft 15 is coupled to, for example, the transmission (not illustrated) of the motorcycle.

The clutch housing 30 is made of an aluminum alloy. The clutch housing 30 has a cylindrical shape having a bottom. As illustrated in FIG. 1, the clutch housing 30 includes a substantially circular bottom wall 31 and a side wall 33 extending in the direction D from an edge of the bottom wall 31. The clutch housing 30 holds the input-side rotary plates 20.

As illustrated in FIG. 1, the input gear 35 is provided on the bottom wall 31 of the clutch housing 30. The input gear 35 is secured through a torque damper 35A to the bottom wall 31 with a rivet 35B. The input gear 35 is in mesh with a driving gear (not illustrated) that rotates in response to rotational driving of the input shaft of the engine. The input gear 35 is rotationally driven independently of the output shaft 15 and together with the clutch housing 30.

The input-side rotary plates 20 are rotationally driven in response to rotational driving of the input shaft. As illustrated in FIG. 1, the input-side rotary plates 20 are held by an inner peripheral surface of the side wall 33 of the clutch housing 30. The input-side rotary plates 20 are in engagement with cut-outs 30C in the side wall 33 of the clutch housing 30 and are thus held by the clutch housing 30. The input-side rotary plates 20 are movable in the axial direction of the clutch housing 30 (i.e., the direction D). The input-side rotary plates 20 are provided to be rotatable together with the clutch housing 30.

The input-side rotary plates 20 are components to be pushed against the output-side rotary plates 22. The input-side rotary plates 20 each have an annular shape. The input-side rotary plates 20 are formed by aluminum die casting. Friction materials (not illustrated) made of pieces of paper are affixed to front and back surfaces of the input-side rotary plates 20. Grooves for retaining clutch oil are provided between the friction materials to a depth of a few or several hundreds of μm.

As illustrated in FIG. 1, the clutch center 40 is housed in the clutch housing 30. The clutch center 40 is disposed concentrically with the clutch housing 30. The clutch center 40 includes a cylindrical body 42 and a center-side flange 68 extending radially outward from an outer peripheral edge of the body 42. The body 42 protrudes in the second direction D2 relative to the center-side flange 68. The clutch center 40 holds some of the output-side rotary plates 22 positioned alternately with the input-side rotary plates 20 in the direction D. The clutch center 40 is rotationally driven together with the output shaft 15.

As illustrated in FIG. 2, the body 42 includes an output shaft holder 50 provided in a central portion of the body 42, a center-side outer peripheral wall 45 located radially outward relative to the output shaft holder 50, and center-side cam portions 60 connected to the output shaft holder 50 and the center-side outer peripheral wall 45.

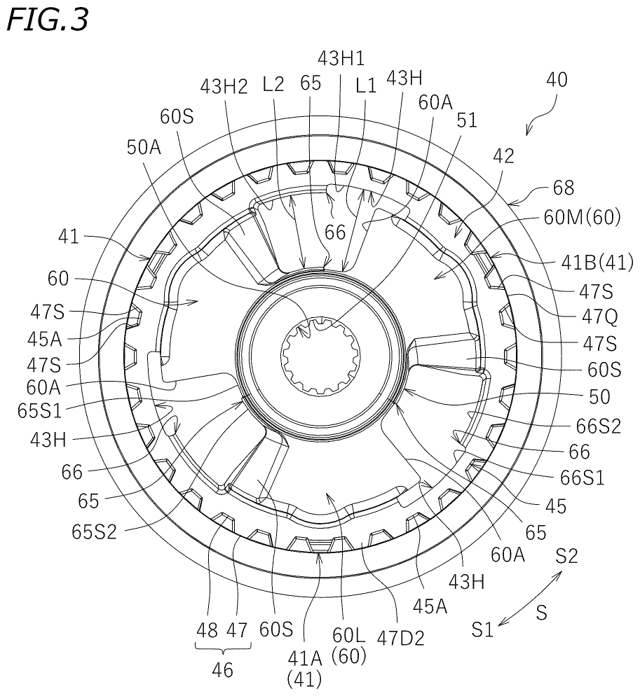

As illustrated in FIGS. 2 and 3, the center-side flange 68 extends radially outward from the outer peripheral edge of the body 42. The center-side flange 68 is located radially outward relative to the center-side cam portions 60. The input-side rotary plates 20 and the output-side rotary plates 22 are held between the center-side flange 68 and a pressure-side flange 98 (which will be described below) of the pressure plate 70. The center-side flange 68 is provided to be able to push the input-side rotary plates 20 and the output-side rotary plates 22. The center-side flange 68 is a component to apply a pushing force to the input-side rotary plates 20 and the output-side rotary plates 22.

As illustrated in FIG. 2, the output shaft holder 50 has a cylindrical shape. The output shaft holder 50 extends in the direction D. An end of the output shaft holder 50 facing in the second direction D2 is located in the second direction D2 relative to the center-side cam portions 60. The output shaft holder 50 is provided with an insertion hole 51 which is defined therethrough and into which the output shaft 15 is to be inserted and spline-fitted. An inner peripheral surface 50A of the output shaft holder 50, which defines the insertion hole 51, is provided with spline grooves extending in its axial direction. The output shaft 15 is coupled to the output shaft holder 50.

As illustrated in FIGS. 2 and 3, the center-side outer peripheral wall 45 has an annular shape extending in the direction D. An outer peripheral surface 45A of the center-side outer peripheral wall 45 is provided with a center-side spline fitting portion 46. The center-side spline fitting portion 46 includes center-side fitting teeth 47 extending in the axial direction of the clutch center 40 along the outer peripheral surface 45A of the center-side outer peripheral wall 45, and center-side spline grooves 48 each provided between adjacent ones of the center-side fitting teeth 47 and extending in the axial direction of the clutch center 40. The center-side fitting teeth 47 hold the output-side rotary plates 22. The center-side fitting teeth 47 are arranged in the circumferential direction S. The center-side fitting teeth 47 are provided at equal intervals in the circumferential direction S. The center-side fitting teeth 47 are similar in shape. The center-side fitting teeth 47 protrude radially outward from the outer peripheral surface 45A of the center-side outer peripheral wall 45. When viewed in the axial direction of the output shaft 15, the center-side fitting teeth 47 each include lateral surfaces 47S facing oppositely in the circumferential direction S, and a top surface 47Q connecting radially outer ends of the lateral surfaces 47S to each other. The center-side spline grooves 48 are arranged in the circumferential direction S. The center-side spline grooves 48 are provided at equal intervals in the circumferential direction S. The center-side spline grooves 48 are similar in shape. When viewed in the axial direction of the output shaft 15, the center-side spline grooves 48 are each defined by the lateral surfaces 47S of the center-side fitting teeth 47 adjacent to each other in the circumferential direction S, and the outer peripheral surface 45A of the center-side outer peripheral wall 45. The center-side outer peripheral wall 45 is provided with oil flow hole(s) 45F defined radially therethrough. The oil flow hole(s) 45F is/are in communication with the center-side spline groove(s) 48.

As illustrated in FIGS. 2 and 3, the clutch center 40 includes center-side protrusions 41. The center-side protrusions 41 are provided on an end 47D2 of the center-side fitting teeth 47 facing in the second direction D2. The center-side protrusions 41 extend in the second direction D2 from the end 47D2 facing in the second direction D2. The center-side protrusions 41 are integral with the center-side fitting teeth 47. The center-side protrusions 41 are arranged in the circumferential direction S. The center-side protrusions 41 are provided at equal intervals in the circumferential direction S. The center-side protrusions 41 are similar in shape. In this example embodiment, the center-side protrusions 41 include, for example, a first center-side protrusion 41A and a second center-side protrusion 41B. A length of the first center-side protrusion 41A in the direction D and a length of the second center-side protrusion 41B in the direction D are equal to each other. The length of the first center-side protrusion 41A in the direction D and the length of the second center-side protrusion 41B in the direction D may be different from each other. The number of center-side protrusions 41 included in the clutch center 40 is three. Alternatively, the number of center-side protrusions 41 included in the clutch center 40 may be one, two, four, or more.

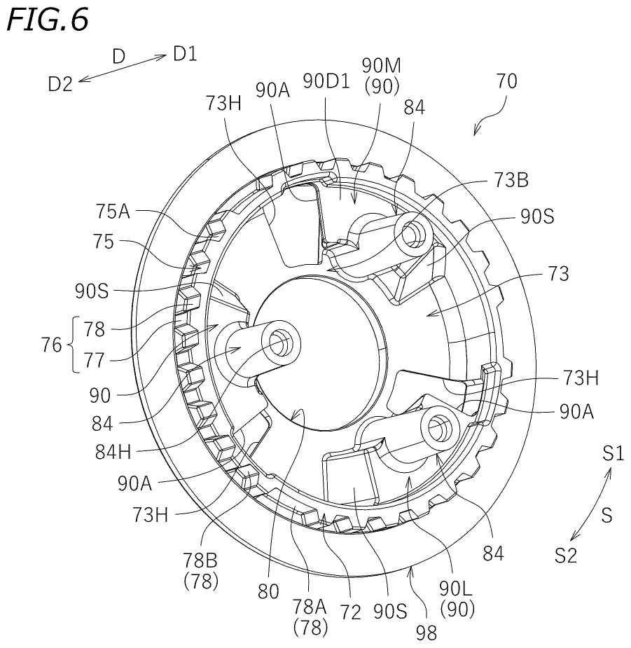

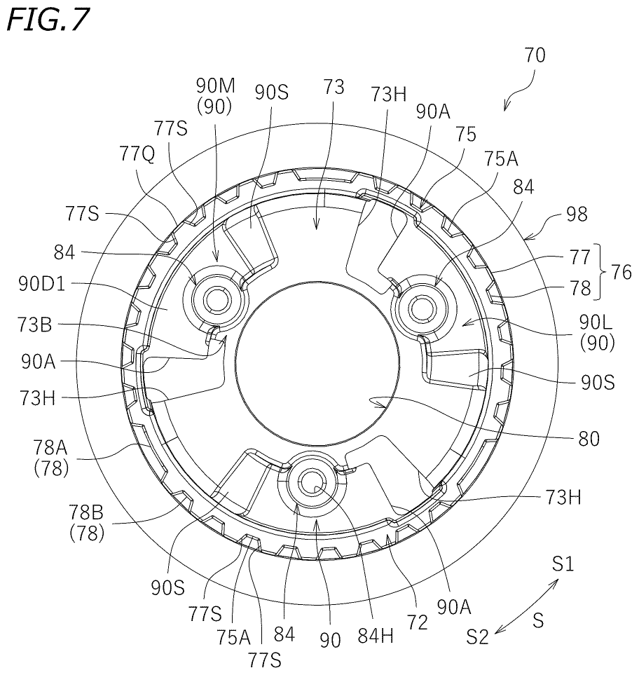

The output-side rotary plates 22 are held by the center-side spline fitting portion 46 of the clutch center 40 and a pressure-side spline fitting portion 76 (which will be described below) of the pressure plate 70. Some of the output-side rotary plates 22 are held by the center-side fitting teeth 47 and the center-side spline grooves 48 of the clutch center 40 through spline-fitting. The remaining one or more output-side rotary plates 22 are held by after-mentioned pressure-side fitting teeth 77 (see FIGS. 6 and 7) and pressure-side spline grooves 78 (see FIGS. 6 and 7) of the pressure plate 70 through spline-fitting. The output-side rotary plates 22 are movable in the axial direction of the clutch center 40. The output-side rotary plates 22 are provided to be rotatable together with the clutch center 40.

The output-side rotary plates 22 are components to be pushed against the input-side rotary plates 20. The output-side rotary plates 22 each have an annular shape. The output-side rotary plates 22 are each formed by punching a thin plate made of an SPCC material into an annular shape. The friction materials provided on the input-side rotary plates 20 may be provided on the output-side rotary plates 22 instead of being provided on the input-side rotary plates 20, or may be provided on both of the input-side rotary plates 20 and the output-side rotary plates 22.

The center-side cam portions 60 are each in the shape of a block with cam surfaces that are inclined surfaces included in an assist & slipper (registered trademark) mechanism for producing an assist torque, which is a force to increase a pushing force (or pressing force) for the input-side rotary plates 20 and the output-side rotary plates 22, or a slipper torque, which is a force to move the input-side rotary plates 20 and the output-side rotary plates 22 away from each other promptly to make a transition to a half-clutch state. The term “half-clutch state” refers to a state between a clutch-engaged state (i.e., a state in which the input-side rotary plates 20 and the output-side rotary plates 22 are pressed against each other) and a clutch-disengaged state (i.e., a state in which the input-side rotary plates 20 and the output-side rotary plates 22 are located away from each other such that clearances are created between the input-side rotary plates 20 and the output-side rotary plates 22). The center-side cam portions 60 are provided on the body 42. Ends of the center-side cam portions 60 facing in the second direction D2 are located in the second direction D2 relative to the center-side outer peripheral wall 45. The center-side cam portions 60 are disposed at equal or substantially equal intervals in the circumferential direction S of the clutch center 40. In the present example embodiment, the number of center-side cam portions 60 included in the clutch center 40 is three. The number of center-side cam portions 60, however, is not limited to three.

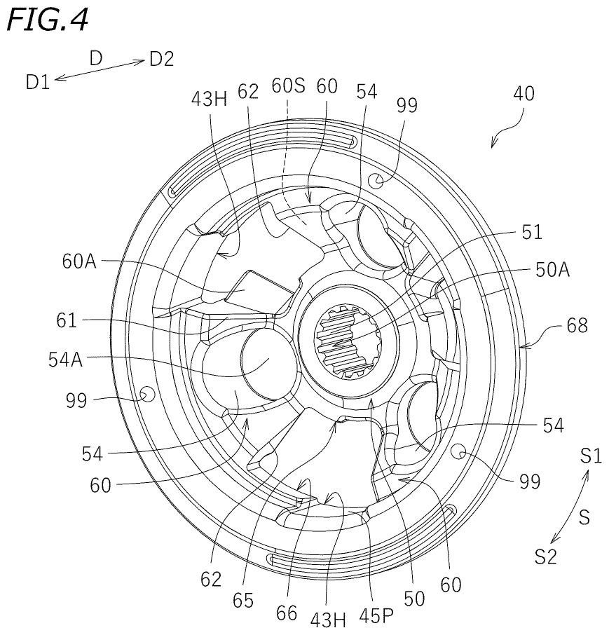

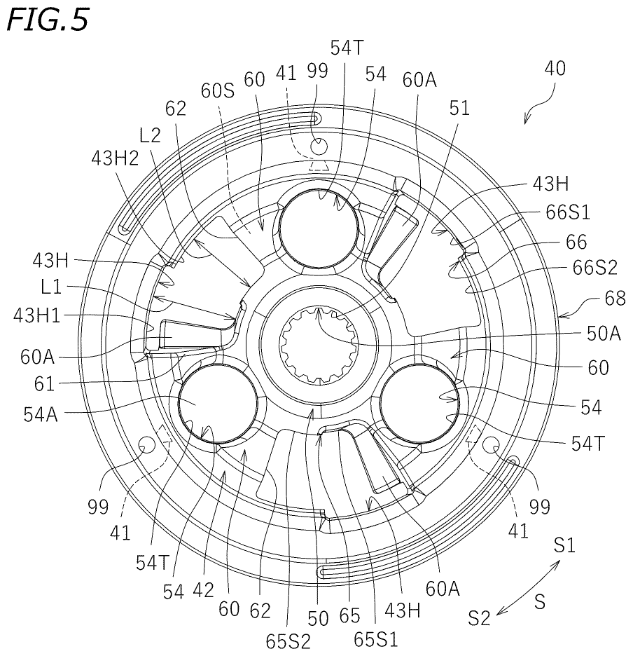

As illustrated in FIG. 2, the center-side cam portions 60 are located radially outward of the output shaft holder 50. The center-side cam portions 60 include center-side assist cam surfaces 60A (see also FIGS. 4 and 5) and center-side slipper cam surfaces 60S. The center-side assist cam surfaces 60A are configured to, upon rotation of the clutch center 40 relative to the pressure plate 70 at the time of, for example, acceleration, produce a force in a direction from the pressure plate 70 toward the clutch center 40 (i.e., in the first direction D1) to increase the pushing force (or pressing force) for the input-side rotary plates 20 and the output-side rotary plates 22. When the force is produced, the present example embodiment involves no change in the position of the pressure plate 70 relative to the clutch center 40 and does not require the pressure plate 70 to physically move toward the clutch center 40. Alternatively, the pressure plate 70 may physically move relative to the clutch center 40. The center-side slipper cam surfaces 60S are configured to, upon rotation of the clutch center 40 relative to the pressure plate 70 at the time of, for example, deceleration, move the pressure plate 70 away from the clutch center 40 to reduce the pushing force (or pressing force) for the input-side rotary plates 20 and the output-side rotary plates 22. The center-side assist cam surface 60A of a first center-side cam portion 60L, which is one of the center-side cam portions 60 adjacent to each other in the circumferential direction S, and the center-side slipper cam surface 60S of a second center-side cam portion 60M, which is another one of the center-side cam portions 60 adjacent to each other in the circumferential direction S, are disposed to face each other in the circumferential direction S.

As illustrated in FIGS. 4 and 5, the center-side cam portions 60 each include a first corner portion 61 and a second corner portion 62. Each first corner portion 61 defines an open end of an associated one of center-side cam holes 43H (which faces in the first direction D1) and is located on a first side in the circumferential direction S of the clutch center 40 (i.e., located in the first circumferential direction S1 in this example embodiment) relative to the associated center-side cam hole 43H. Each first corner portion 61 is located adjacent to the associated center-side assist cam surface 60A. Each first corner portion 61 is provided by rounding an angular corner to form a “radius”. Each second corner portion 62 defines an open end of an associated one of the center-side cam holes 43H (which faces in the first direction D1) and is located on a second side in the circumferential direction S of the clutch center 40 (i.e., located in the second circumferential direction S2 in this example embodiment) relative to the associated center-side cam hole 43H. Each second corner portion 62 is located adjacent to the associated center-side slipper cam surface 60S. Each second corner portion 62 includes a “sharp corner” with a pointed tip.

As illustrated in FIGS. 3 and 5, the clutch center 40 includes the center-side cam holes 43H each defined through a portion of the body 42. The center-side cam holes 43H extend through the body 42 in the direction D. The center-side cam holes 43H each extend to the center-side outer peripheral wall 45 from a portion of the clutch center 40 radially outward of the output shaft holder 50. Each center-side cam hole 43H is provided between the center-side assist cam surface 60A and the center-side slipper cam surface 60S of the associated center-side cam portions 60 adjacent to each other. Each center-side cam hole 43H includes a first portion 43H1 located adjacent to the associated center-side assist cam surface 60A, and a second portion 43H2 located adjacent to the associated center-side slipper cam surface 60S. A radial length L1 of each first portion 43H1 is longer than a radial length L2 of each second portion 43H2. After-mentioned bosses 84 (see FIG. 1) of the pressure plate 70 are each inserted into an associated one of the center-side cam holes 43H. When viewed in the axial direction of the clutch center 40 (i.e., the axial direction of the output shaft 15), the center-side assist cam surfaces 60A and portions of the center-side cam holes 43H overlap with each other.

As illustrated in FIGS. 2 to 5, the clutch center 40 includes radially inner stepped portions 65. The radially inner stepped portions 65 are provided on radially outer surfaces 50J (see FIG. 2) of the output shaft holder 50. The radially inner stepped portions 65 extend in the direction D. The radially inner stepped portions 65 define portions of the center-side cam holes 43H. When viewed in the axial direction of the output shaft 15, regions 65S2 of the radially inner stepped portions 65 situated in the second circumferential direction S2 are located radially outward relative to regions 65S1 of the radially inner stepped portions 65 situated in the first circumferential direction S1.

As illustrated in FIGS. 2 to 5, the clutch center 40 includes radially outer stepped portions 66. The radially outer stepped portions 66 are provided on radially inner surfaces 45P (see FIG. 4) of the center-side outer peripheral wall 45. The radially outer stepped portions 66 extend in the direction D. The radially outer stepped portions 66 define portions of the center-side cam holes 43H. When viewed in the axial direction of the output shaft 15, regions 66S2 of the radially outer stepped portions 66 situated in the second circumferential direction S2 are located radially inward relative to regions 66S1 of the radially outer stepped portions 66 situated in the first circumferential direction S1.

As illustrated in FIGS. 4 and 5, the clutch center 40 includes spring housing portions 54. The spring housing portions 54 are each an example of a housing portion. The spring housing portions 54 are recessed in the second direction D2 from the first direction D1. The spring housing portions 54 are provided in the body 42. More specifically, the spring housing portions 54 are provided in the center-side cam portions 60. The spring housing portions 54 house clutch springs 25 (see FIG. 1). In the present example embodiment, the number of spring housing portions 54 included in the clutch center 40 is three, for example. The three spring housing portions 54 are disposed at equal or substantially equal intervals in the circumferential direction S of the clutch center 40. The number of spring housing portions 54, however, is not limited to three. Each spring housing portion 54 is located in the second circumferential direction S2 relative to the associated center-side slipper cam surface 60S. Each spring housing portion 54 is located in the first circumferential direction S1 relative to the associated first corner portion 61. Each spring housing portion 54 is located in the first circumferential direction S1 relative to the associated center-side assist cam surface 60A. Each spring housing portion 54 includes a bottom wall 54A that comes into contact with an end 25D2 of the associated clutch spring 25 facing in the second direction D2. A length of each center-side cam hole 43H in the circumferential direction S is longer than a length of each spring housing portion 54 in the circumferential direction S. As illustrated in FIG. 5, at least portions of the center-side protrusions 41 are located radially outward of the spring housing portions 54. The center-side protrusions 41 are located radially outward of radially outer ends 54T of the spring housing portions 54.

As illustrated in FIG. 1, the clutch springs 25 are housed in the spring housing portions 54. The clutch springs 25 urge the pressure plate 70 toward the clutch center 40 in the direction D (i.e., urge the pressure plate 70 in the first direction D1). The clutch springs 25 are, for example, coil springs provided by spirally winding spring steel.

As illustrated in FIGS. 4 and 5, the clutch center 40 includes recesses 99 provided in the center-side flange 68. The recesses 99 are located radially outward of the spring housing portions 54. The recesses 99 are recessed in the second direction D2 from the first direction D1. The recesses 99 are recessed to, for example, a depth of between about 0.1 mm and about 0.5 mm, inclusive, measured from a surface of the center-side flange 68 facing in the first direction D1. The recesses 99 may be recessed to a depth greater than about 0 mm and less than about 0.1 mm, measured from the surface of the center-side flange 68 facing in the first direction D1. At least a portion of each center-side protrusion 41 is located between the associated spring housing portion 54 and the associated recess 99 in a radial direction.

As illustrated in FIG. 1, the clutch center 40 is provided with an urging member 68S. The urging member 68S is, for example, a disc spring. The urging member 68S is provided on the center-side flange 68. The urging member 68S is provided to be able to come into contact with one of the output-side rotary plates 22 held by the center-side fitting teeth 47. The urging member 68S is configured to damp an assisting force (which is produced upon contact of the center-side assist cam surfaces 60A with after-mentioned pressure-side assist cam surfaces 90A) in order to prevent a sudden increase in the pressing force for the input-side rotary plates 20 and the output-side rotary plates 22, which is caused by the assisting force produced.

As illustrated in FIG. 1, the pressure plate 70 is housed in the clutch housing 30. The pressure plate 70 is located between the clutch housing 30 and the clutch center 40. The pressure plate 70 is provided to be movable toward or away from the clutch center 40. The pressure plate 70 is rotatable relative to the clutch center 40. The pressure plate 70 is configured to be able to push the input-side rotary plates 20 and the output-side rotary plates 22. The pressure plate 70 is disposed concentrically with the clutch center 40 and the clutch housing 30. As illustrated in FIG. 6, the pressure plate 70 includes a cylindrical body 72 and the pressure-side flange 98 connected to an outer peripheral edge of the body 72 (which is located in the second direction D2) and extending radially outward therefrom. The body 72 protrudes in the first direction D1 relative to the pressure-side flange 98. The pressure plate 70 holds some of the output-side rotary plates 22 positioned alternately with the input-side rotary plates 20.

As illustrated in FIGS. 6 and 7, the body 72 includes an annular base wall 73, a fitting hole 80 provided in a central portion of the base wall 73, a pressure-side outer peripheral wall 75 located radially outward of the base wall 73 and extending in the first direction D1, and pressure-side cam portions 90 connected to the base wall 73 and the pressure-side outer peripheral wall 75.

As illustrated in FIGS. 6 and 7, the pressure-side flange 98 extends radially outward from the outer peripheral edge of the body 72. The pressure-side flange 98 is located radially outward relative to the pressure-side cam portions 90. The input-side rotary plates 20 and the output-side rotary plates 22 are held between the pressure-side flange 98 and the center-side flange 68 of the clutch center 40. The pressure-side flange 98 is provided to be able to push the input-side rotary plates 20 and the output-side rotary plates 22. The pressure-side flange 98 is a component to apply a pushing force to the input-side rotary plates 20 and the output-side rotary plates 22.

As illustrated in FIGS. 6 and 7, the fitting hole 80 is provided in a central portion of the body 72. The fitting hole 80 is defined through the base wall 73 in the direction D. The output shaft holder 50 (see FIG. 2) of the clutch center 40 is inserted into the fitting hole 80. The output shaft holder 50 is fitted into the fitting hole 80 to be externally surrounded by the fitting hole 80.

FIGS. 6 and 7, the pressure-side outer peripheral wall 75 has an annular shape extending in the direction D. An outer peripheral surface 75A of the pressure-side outer peripheral wall 75 is provided with the pressure-side spline fitting portion 76. The pressure-side spline fitting portion 76 includes the pressure-side fitting teeth 77 extending in the axial direction of the pressure plate 70 along the outer peripheral surface 75A of the pressure-side outer peripheral wall 75, and the pressure-side spline grooves 78 each provided between adjacent ones of the pressure-side fitting teeth 77 and extending in the axial direction of the pressure plate 70. The pressure-side fitting teeth 77 hold the output-side rotary plates 22. The pressure-side fitting teeth 77 are arranged in the circumferential direction S. The pressure-side fitting teeth 77 are similar in shape. The pressure-side fitting teeth 77 protrude radially outward from the outer peripheral surface 75A of the pressure-side outer peripheral wall 75. When viewed in the axial direction of the output shaft 15, the pressure-side fitting teeth 77 each include lateral surfaces 77S facing oppositely in the circumferential direction S, and a top surface 77Q connecting radially outer ends of the lateral surfaces 77S to each other. In the present example embodiment, the pressure-side fitting teeth 77 and the center-side fitting teeth 47 are similar in external shape when viewed in the axial direction of the output shaft 15. The pressure-side spline grooves 78 are arranged in the circumferential direction S. When viewed in the axial direction of the output shaft 15, the pressure-side spline grooves 78 are each defined by the lateral surfaces 77S of the pressure-side fitting teeth 77 adjacent to each other in the circumferential direction S, and the outer peripheral surface 75A of the pressure-side outer peripheral wall 75. The pressure-side spline grooves 78 include first pressure-side spline grooves 78A whose lengths in the circumferential direction S are long, and second pressure-side spline grooves 78B whose lengths in the circumferential direction S are short.

The pressure-side cam portions 90 are each in the shape of a block with cam surfaces that are inclined surfaces included in an assist & slipper (registered trademark) mechanism, which slides relative to the center-side cam portions 60 to produce an assist torque or a slipper torque. The pressure-side cam portions 90 are protruding in the first direction D1 relative to the pressure-side flange 98. As illustrated in FIG. 7, the pressure-side cam portions 90 are disposed at equal or substantially equal intervals in the circumferential direction S of the pressure plate 70. In the present example embodiment, the number of pressure-side cam portions 90 included in the pressure plate 70 is three. The number of pressure-side cam portions 90, however, is not limited to three.

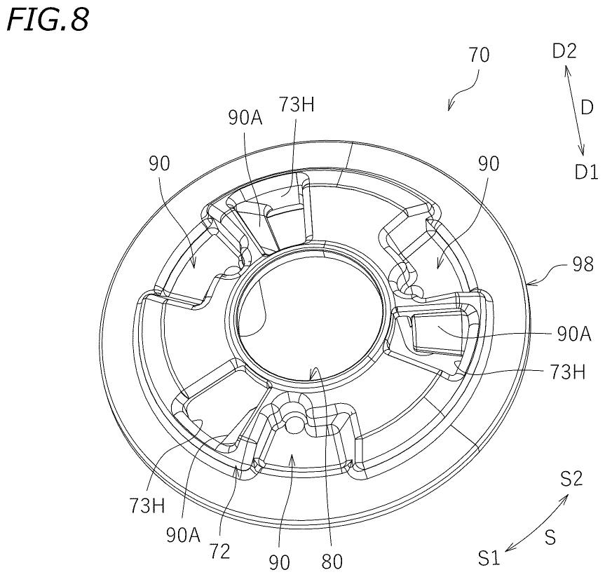

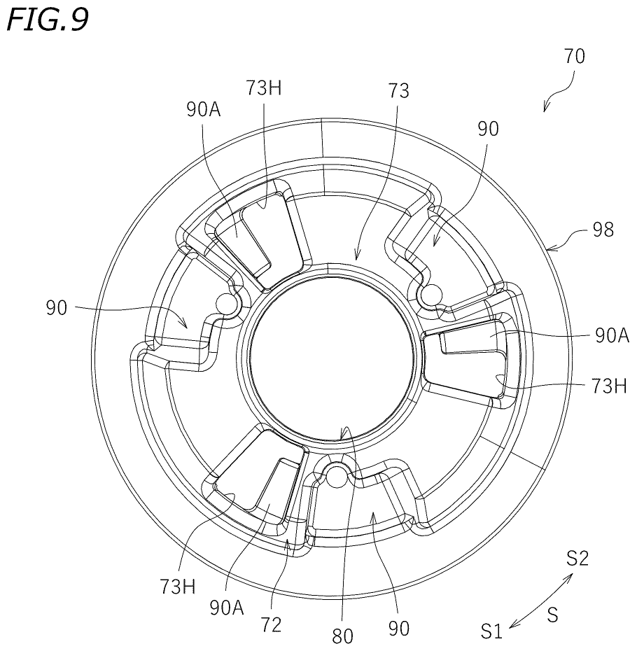

As illustrated in FIG. 6, the pressure-side cam portions 90 are located radially outward of the fitting hole 80. The pressure-side cam portions 90 include the pressure-side assist cam surfaces 90A (see also FIGS. 8 and 9) and pressure-side slipper cam surfaces 90S. The pressure-side assist cam surfaces 90A are configured to be able to come into contact with the center-side assist cam surfaces 60A. The pressure-side assist cam surfaces 90A are configured to, upon rotation of the pressure plate 70 relative to the clutch center 40 at the time of, for example, acceleration, produce a force in the direction from the pressure plate 70 toward the clutch center 40 to increase the pushing force (or pressing force) for the input-side rotary plates 20 and the output-side rotary plates 22. The pressure-side slipper cam surfaces 90S are configured to be able to come into contact with the center-side slipper cam surfaces 60S. The pressure-side slipper cam surfaces 90S are configured to, upon rotation of the pressure plate 70 relative to the clutch center 40 at the time of, for example, deceleration, move the pressure plate 70 away from the clutch center 40 to reduce the pushing force (or pressing force) for the input-side rotary plates 20 and the output-side rotary plates 22. The pressure-side assist cam surface 90A of a first pressure-side cam portion 90L, which is one of the pressure-side cam portions 90 adjacent to each other in the circumferential direction S, and the pressure-side slipper cam surface 90S of a second pressure-side cam portion 90M, which is another one of the pressure-side cam portions 90 adjacent to each other in the circumferential direction S, are disposed to face each other in the circumferential direction S.

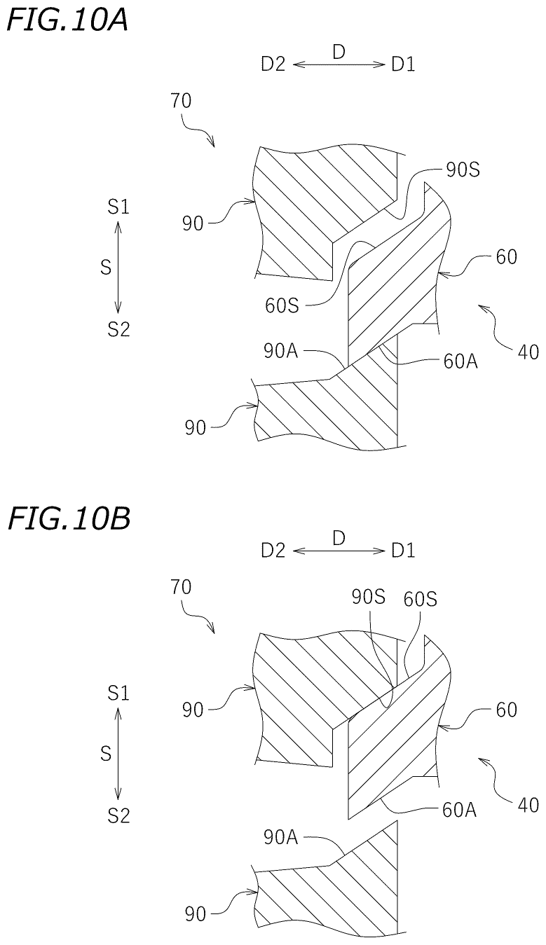

Actions of the center-side cam portions 60 and the pressure-side cam portions 90 will be described below. When the engine is increased in rotational speed such that a rotational driving force input to the input gear 35 and the clutch housing 30 is transmittable to the output shaft 15 through the clutch center 40, a rotational force is applied to the pressure plate 70 in the first circumferential direction S1 as illustrated in FIG. 10A. Thus, actions of the center-side assist cam surfaces 60A and the pressure-side assist cam surfaces 90A apply a force to the pressure plate 70 in the first direction D1. This increases the pressing force for the input-side rotary plates 20 and the output-side rotary plates 22. With the center-side assist cam surfaces 60A and the pressure-side assist cam surfaces 90A in contact with each other, an increase in rotational speed of the engine involves no change in the physical position of the pressure plate 70 relative to the clutch center 40 in the direction D. Alternatively, with the center-side assist cam surfaces 60A and the pressure-side assist cam surfaces 90A in contact with each other, an increase in rotational speed of the engine may involve a change in the physical position of the pressure plate 70 relative to the clutch center 40 in the direction D.

When the output shaft 15 is higher in rotational speed than the input gear 35 and the clutch housing 30 such that a back torque is produced, a rotational force is applied to the clutch center 40 in the first circumferential direction S1 as illustrated in FIG. 10B. Thus, actions of the center-side slipper cam surfaces 60S and the pressure-side slipper cam surfaces 90S move the pressure plate 70 in the second direction D2 to release the pressing force for the input-side rotary plates 20 and the output-side rotary plates 22. This makes it possible to prevent the engine and/or the transmission from encountering a malfunction caused by the back torque. Suppose that, with the center-side slipper cam surfaces 60S and the pressure-side slipper cam surfaces 90S in contact with each other, the degree by which the rotational speed of the output shaft 15 exceeds the rotational speed of the input gear 35 and the clutch housing 30 has increased gradually, i.e., the back torque has increased gradually. In this case, the pressure plate 70 moves in the second direction D2 relative to the clutch center 40 while the center-side slipper cam surfaces 60S and the pressure-side slipper cam surfaces 90S are kept in contact with each other.

As illustrated in FIGS. 7 and 9, the pressure plate 70 includes pressure-side cam holes 73H each defined through a portion of the base wall 73. The pressure-side cam holes 73H extend through the base wall 73 in the direction D. The pressure-side cam holes 73H are located radially outward relative to the fitting hole 80. The pressure-side cam holes 73H each extend to the pressure-side outer peripheral wall 75 from a position lateral to the fitting hole 80. The pressure-side cam holes 73H are each defined through a portion of the base wall 73 located between the pressure-side cam portions 90 adjacent to each other. The pressure-side cam holes 73H are each defined through a portion of the base wall 73 located between the pressure-side assist cam surface 90A and the pressure-side slipper cam surface 90S of the pressure-side cam portions 90 adjacent to each other. When viewed in the axial direction of the pressure plate 70, the pressure-side assist cam surfaces 90A and portions of the pressure-side cam holes 73H overlap with each other.

As illustrated in FIGS. 6 and 7, the pressure plate 70 includes the bosses 84 (the number of which is three in the present example embodiment). The bosses 84 are disposed at equal or substantially equal intervals in the circumferential direction S. The bosses 84 each have a cylindrical shape. The bosses 84 are located radially outward relative to the fitting hole 80. The bosses 84 extend in the first direction D1 from the base wall 73. The bosses 84 are provided in the pressure-side cam portions 90. The bosses 84 are each located between the associated pressure-side assist cam surface 90A and the associated pressure-side slipper cam surface 90S in the circumferential direction S. As illustrated in FIG. 1, the bosses 84 are each inserted into the associated center-side cam hole 43H. The bosses 84 are provided with threaded holes 84H into which bolts 28 are to be inserted. The threaded holes 84H extend in the direction D.

As illustrated in FIG. 1, the stopper plate 100 is provided to be able to come into contact with the clutch center 40. The stopper plate 100 is a component to prevent the pressure plate 70 from moving away from the clutch center 40 in the second direction D2 by a predetermined distance or more. The stopper plate 100 is a component to shift the pressure plate 70 in the direction D. An end 25D1 of each clutch spring 25 facing in the first direction D1 comes into contact with the stopper plate 100. The stopper plate 100 is secured to the pressure plate 70 with the bolts 28. The stopper plate 100 rotates together with the pressure plate 70. The stopper plate 100 moves in the direction D relative to the clutch center 40 and rotates relative to the clutch center 40. The stopper plate 100 is actuated by a clutch release mechanism (not illustrated). As used herein, the term “clutch release mechanism” refers to a mechanical device that is actuated in response to an operation performed on a clutch operation lever (not illustrated) by a driver of a vehicle, such as a motorcycle, on which the clutch apparatus 10 is installed. The clutch release mechanism may be electrically actuated by, for example, a servomotor.

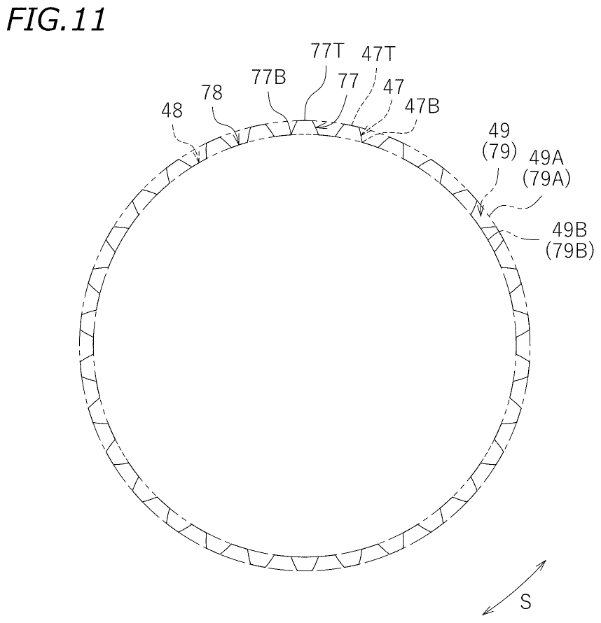

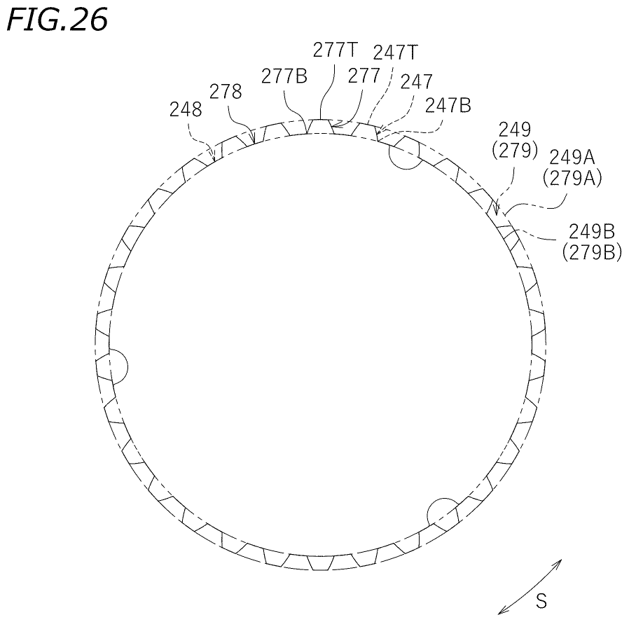

As illustrated in FIG. 11, when viewed in the axial direction of the output shaft 15, a center-side annular portion 49 having an annular shape at least partially overlaps with a pressure-side annular portion 79 having an annular shape. In the present example embodiment, an entirety of the center-side annular portion 49 overlaps with an entirety of the pressure-side annular portion 79. When viewed in the axial direction of the output shaft 15, the center-side annular portion 49 is bounded in a radial direction by a center-side tooth tip circle 49A passing through tooth tips 47T (i.e., the top surfaces 47Q) that are radially outermost portions of the center-side fitting teeth 47, and a center-side tooth bottom circle 49B passing through tooth bottoms 47B that are radially innermost portions of the center-side fitting teeth 47. The tooth bottoms 47B are continuous with the outer peripheral surface 45A of the center-side outer peripheral wall 45 and correspond in position to the outer peripheral surface 45A in the radial direction. When viewed in the axial direction of the output shaft 15, the pressure-side annular portion 79 is bounded in the radial direction by a pressure-side tooth tip circle 79A passing through tooth tips 77T (i.e., the top surfaces 77Q) that are radially outermost portions of the pressure-side fitting teeth 77, and a pressure-side tooth bottom circle 79B passing through tooth bottoms 77B that are radially innermost portions of the pressure-side fitting teeth 77. The tooth bottoms 77B are continuous with the outer peripheral surface 75A of the pressure-side outer peripheral wall 75 and correspond in position to the outer peripheral surface 75A in the radial direction. In FIG. 11, the center-side fitting teeth 47 and the center-side spline grooves 48 are represented by broken lines, and the pressure-side fitting teeth 77 and the pressure-side spline grooves 78 are represented by solid lines. A positional relationship between the pressure-side fitting teeth 77 and the center-side fitting teeth 47 when viewed in the axial direction of the output shaft 15 and a positional relationship between the pressure-side fitting teeth 77 and the center-side fitting teeth 47 when viewed in the radial direction of the output shaft 15 are similar to those between pressure-side fitting teeth 277 and center-side fitting teeth 247 according to a second example embodiment (see FIGS. 26 to 29), which will be described below.

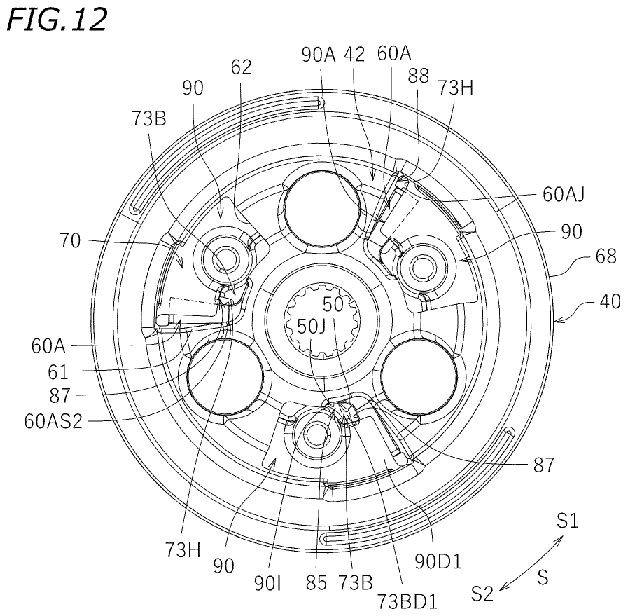

As illustrated in FIG. 12, with the center-side assist cam surfaces 60A and the pressure-side assist cam surfaces 90A in contact with each other, first clearances 87 that extend through the clutch center 40 and the pressure plate 70 in the direction D and that overlap with the pressure-side cam holes 73H are disposed in the second circumferential direction S2 relative to ends 60AS2 of the center-side assist cam surfaces 60A (which face in the second circumferential direction S2) when viewed in the axial direction of the output shaft 15 (e.g., when viewed in the second direction D2 from the first direction D1). Each first clearance 87 is defined by the associated end 60AS2, the associated pressure-side cam portion 90, and a pressure-side bottom wall 73B. As illustrated in FIGS. 6 and 7, the pressure-side bottom wall 73B is a portion of the base wall 73 and located radially outward relative to the fitting hole 80. The pressure-side bottom wall 73B is located radially inward relative to the pressure-side cam portions 90. The pressure-side bottom wall 73B is located in the second direction D2 relative to ends 90D1 of the pressure-side cam portions 90 facing in the first direction D1.

As illustrated in FIG. 12, with the center-side assist cam surfaces 60A and the pressure-side assist cam surfaces 90A in contact with each other, recesses 85 recessed in the second direction D2 are defined by the clutch center 40 and the pressure plate 70. Each recess 85 is defined by a radially inner surface 90I of the associated pressure-side cam portion 90, a surface 73BD1 of the pressure-side bottom wall 73B facing in the first direction D1, and a radially outer surface 50J of the output shaft holder 50. The recesses 85 are located in the second circumferential direction S2 relative to the first clearances 87.

As illustrated in FIG. 12, with the center-side assist cam surfaces 60A and the pressure-side assist cam surfaces 90A in contact with each other, second clearances 88 that extend through the clutch center 40 and the pressure plate 70 in the direction D and that overlap with the pressure-side cam holes 73H are disposed radially outward of the center-side assist cam surfaces 60A when viewed in the axial direction of the output shaft 15. Each second clearance 88 is defined by a radially outer end 60AJ of the associated center-side assist cam surface 60A, the associated pressure-side cam portion 90, and the body 42.

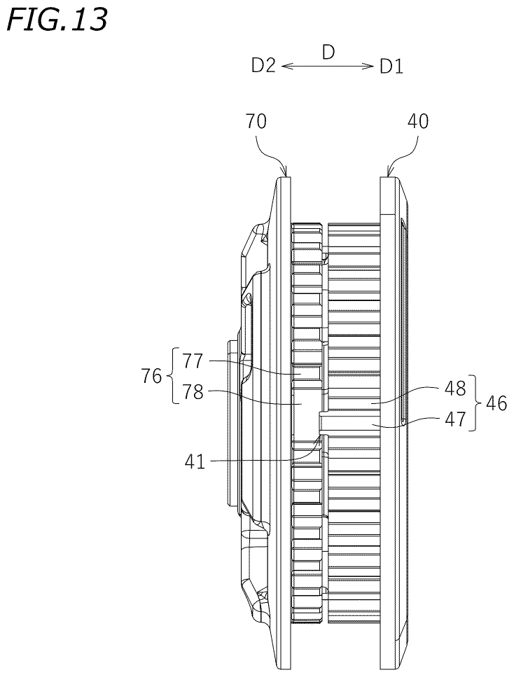

As illustrated in FIG. 13, during at least part of the half-clutch state, at least a portion of each center-side protrusion 41 overlaps with the associated pressure-side spline groove 78 when viewed in the radial direction of the output shaft 15. Throughout the half-clutch state, at least a portion of each center-side protrusion 41 may overlap with the associated pressure-side spline groove 78 when viewed in the radial direction of the output shaft 15. During the clutch-disengaged state, at least a portion of each center-side protrusion 41 may overlap with the associated pressure-side spline groove 78 when viewed in the radial direction of the output shaft 15. During at least part of (e.g., throughout) a state in which the center-side slipper cam surfaces 60S and the pressure-side slipper cam surfaces 90S are in contact with each other, at least a portion of each center-side protrusion 41 may overlap with the associated pressure-side spline groove 78 when viewed in the radial direction of the output shaft 15. With the center-side assist cam surfaces 60A and the pressure-side assist cam surfaces 90A in contact with each other, at least a portion of each center-side protrusion 41 may overlap with the associated pressure-side spline groove 78 when viewed in the radial direction of the output shaft 15. With the clutch center 40 and the stopper plate 100 in contact with each other, at least a portion of each center-side protrusion 41 may overlap with the associated pressure-side spline groove 78 when viewed in the radial direction of the output shaft 15. The state illustrated in FIG. 13 in which a portion of each center-side protrusion 41 overlaps with the associated pressure-side spline groove 78 may be an example of each of the states mentioned above.

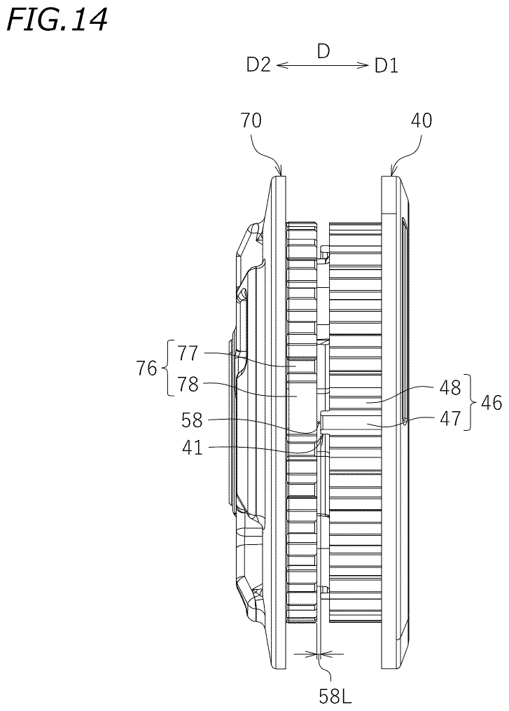

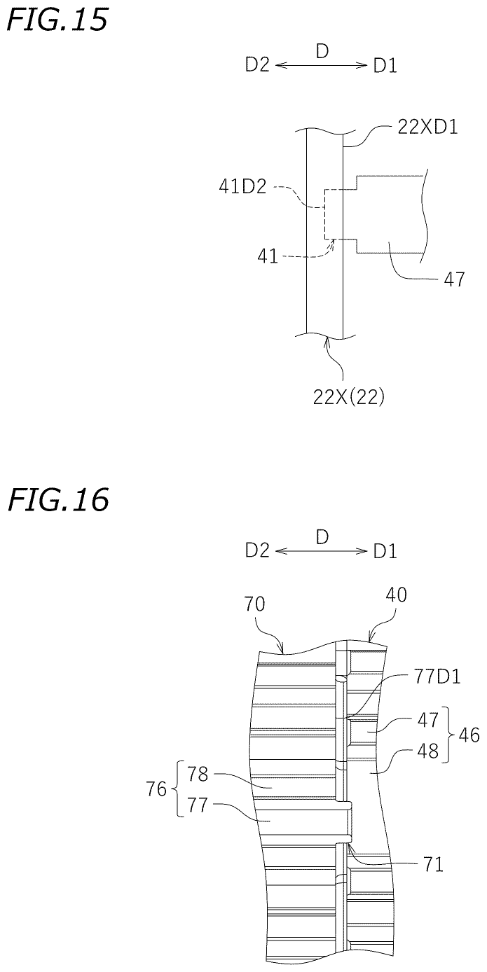

As illustrated in FIG. 14, with the clutch center 40 and the stopper plate 100 in contact with each other, a clearance 58 may be created between each center-side protrusion 41 and the pressure plate 70 in the direction D when viewed in the radial direction of the output shaft 15. A length 58L of each clearance 58 in the direction D is shorter than a length 22L (see FIG. 1) of each output-side rotary plate 22 in the direction D. As illustrated in FIG. 15, assuming that the output-side rotary plate 22 located farthest in the second direction D2 among those held by the center-side fitting teeth 57, with the pressure plate 70 located closest to the clutch center 40, is defined as an “outermost output-side rotary plate 22X”, a surface 22XD1 of the outermost output-side rotary plate 22X facing in the first direction D1 is located in the first direction D1 relative to an end 41D2 of each center-side protrusion 41 facing in the second direction D2, with the clutch center 40 and the stopper plate 100 in contact with each other.

In the foregoing example embodiment, the clutch center 40 includes the center-side protrusions 41 and is configured such that during at least part of the half-clutch state, for example, at least a portion of each center-side protrusion 41 overlaps with the associated pressure-side spline groove 78 when viewed in the radial direction of the output shaft 15. The present invention, however, is not limited to this arrangement. As illustrated in FIG. 16, the pressure plate 70, for example, may include pressure-side protrusions 71 and may be configured such that during at least part of the half-clutch state, for example, at least a portion of each pressure-side protrusion 71 overlaps with the associated center-side spline groove 48 when viewed in the radial direction of the output shaft 15. The pressure-side protrusions 71 are provided on an end 77D1 of the pressure-side fitting teeth 77 facing in the first direction D1. The pressure-side protrusions 71 extend in the first direction D1 from the end 77D1 facing in the first direction D1. A positional relationship between the pressure-side protrusions 71 and the center-side spline grooves 48 may be similar to that between the center-side protrusions 41 and the pressure-side spline grooves 78. Alternatively, the clutch center 40 may include the center-side protrusions 41, the pressure plate 70 may include the pressure-side protrusions 71, and the clutch center 40 and the pressure plate 70 may be configured such that during at least one of states (a) to (f) described below, at least portions of the center-side protrusions 41 overlap with the pressure-side spline grooves 78 and at least portions of the pressure-side protrusions 71 overlap with the center-side spline grooves 48 when viewed in the radial direction of the output shaft 15. The state (a) is a state corresponding to at least part of a period during which the half-clutch state occurs. The state (b) is a state corresponding to the entire period during which the half-clutch state occurs. The state (c) is the clutch-disengaged state. The state (d) is the state in which the center-side slipper cam surfaces 60S and the pressure-side slipper cam surfaces 90S are in contact with each other. The state (e) is the state in which the center-side assist cam surfaces 60A and the pressure-side assist cam surfaces 90A are in contact with each other. The state (f) is the state in which the clutch center 40 and the stopper plate 100 are in contact with each other. A length of each center-side protrusion 41 in the direction D and a length of each pressure-side protrusion 71 in the direction D may be equal to each other or may be different from each other.

In the clutch apparatus 10 according to the present example embodiment, during at least part of the half-clutch state, at least portions of the center-side protrusions 41 overlap, as described above, with the pressure-side spline grooves 78 when viewed in the radial direction of the output shaft 15. During at least part of the half-clutch state, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

In the clutch apparatus 10 according to the present example embodiment, during the clutch-disengaged state, at least portions of the center-side protrusions 41 may overlap with the pressure-side spline grooves 78 when viewed in the radial direction of the output shaft 15. During the clutch-disengaged state, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

In the clutch apparatus 10 according to the present example embodiment, with the center-side slipper cam surfaces 60S and the pressure-side slipper cam surfaces 90S in contact with each other, at least portions of the center-side protrusions 41 may overlap with the pressure-side spline grooves 78 when viewed in the radial direction of the output shaft 15. With the center-side slipper cam surfaces 60S and the pressure-side slipper cam surfaces 90S in contact with each other, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

In the clutch apparatus 10 according to the present example embodiment, with the clutch center 40 and the stopper plate 100 in contact with each other, at least portions of the center-side protrusions 41 may overlap with the pressure-side spline grooves 78 when viewed in the radial direction of the output shaft 15. With the clutch center 40 and the stopper plate 100 in contact with each other, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

In the clutch apparatus 10 according to the present example embodiment, with the clutch center 40 and the stopper plate 100 in contact with each other, the clearance 58 may be created between each center-side protrusion 41 and the pressure plate 70 in the direction D when viewed in the radial direction of the output shaft 15, and the length 58L of each clearance 58 in the direction D may be shorter than the length 22L of each output-side rotary plate 22 in the direction D. With the clutch center 40 and the stopper plate 100 in contact with each other, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

In the clutch apparatus 10 according to the present example embodiment, with the clutch center 40 and the stopper plate 100 in contact with each other, the surface 22XD1 of the outermost output-side rotary plate 22X facing in the first direction D1 may be located in the first direction D1 relative to the end 41D2 of each center-side protrusion 41 facing in the second direction D2. With the clutch center 40 and the stopper plate 100 in contact with each other, this example embodiment would be able to prevent the output-side rotary plates 22, which are held by the pressure-side fitting teeth 77 and the center-side fitting teeth 47, from being disengaged from the pressure-side fitting teeth 77 and the center-side fitting teeth 47 if the clearance is created between each center-side protrusion 41 and the pressure plate 70.

In the clutch apparatus 10 according to the present example embodiment, the center-side protrusions 41 are located radially outward of the spring housing portions 54. Although a large force is applied through the output-side rotary plates 22 to portions of the center-side protrusions 41 adjacent to their roots during rotation of the clutch center 40, this example embodiment involves providing the spring housing portions 54 adjacent to the roots of the center-side protrusions 41 and thus increases their rigidity, resulting in enhanced durability of the clutch center 40.

In the clutch apparatus 10 according to the present example embodiment, at least portions of the center-side protrusions 41 are located radially outward of the radially outer ends 54T of the spring housing portions 54. Although a large force is applied through the output-side rotary plates 22 to the portions of the center-side protrusions 41 adjacent to their roots during rotation of the clutch center 40, this example embodiment involves providing the spring housing portions 54 adjacent to the roots of the center-side protrusions 41 and thus increases their rigidity, resulting in enhanced durability of the clutch center 40.

In the clutch apparatus 10 according to the present example embodiment, the length of the first center-side protrusion 41A in the direction D and the length of the second center-side protrusion 41B in the direction D may be different from each other. This example embodiment does not require increasing the lengths of all of the center-side protrusions 41 and is thus able to prevent the output-side rotary plates 22 from being disengaged from the pressure-side fitting teeth 77 and the center-side fitting teeth 47, while limiting a weight increase caused by providing the center-side protrusions 41.

In the clutch apparatus 10 according to the present example embodiment, throughout the half-clutch state, at least portions of the center-side protrusions overlap with the pressure-side spline grooves when viewed in the radial direction of the output shaft. Throughout the half-clutch state, this example embodiment is able to prevent the output-side rotary plates, which are held by the pressure-side fitting teeth and the center-side fitting teeth, from being disengaged from the pressure-side fitting teeth and the center-side fitting teeth.

In the clutch apparatus 10 according to the present example embodiment, with the center-side assist cam surfaces 60A and the pressure-side assist cam surfaces 90A in contact with each other, at least portions of the center-side protrusions 41 may overlap with the pressure-side spline grooves 78 when viewed in the radial direction of the output shaft 15. With the center-side assist cam surfaces 60A and the pressure-side assist cam surfaces 90A in contact with each other, this example embodiment is able to prevent the output-side rotary plates 22, which are held by the pressure-side fitting teeth 77 and the center-side fitting teeth 47, from being disengaged from the pressure-side fitting teeth 77 and the center-side fitting teeth 47.

### Second Example Embodiment

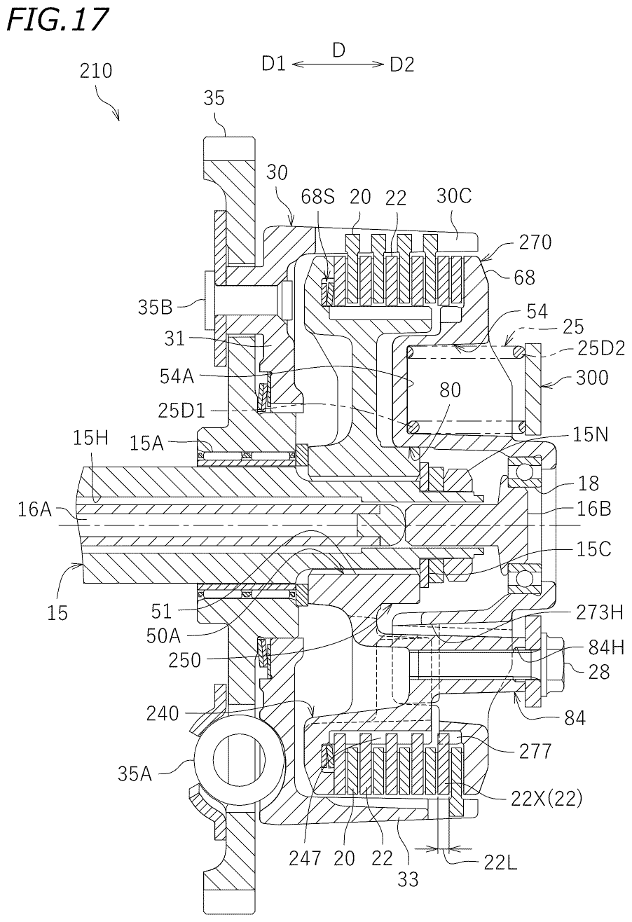

FIG. 17 is a cross-sectional view of a clutch apparatus 210 according to a second example embodiment. The clutch apparatus 210 is installed, for example, on a vehicle, such as a motorcycle. The clutch apparatus 210 is, for example, an apparatus to transmit a rotational driving force of an input shaft (e.g., a crankshaft), which is included in an engine mounted on a motorcycle, to an output shaft 15 or cut off the rotational driving force. The clutch apparatus 210 is an apparatus to transmit the rotational driving force of the input shaft to a driving wheel (e.g., a rear wheel) through the output shaft 15 or cut off the rotational driving force. The clutch apparatus 210 is disposed between the engine and a transmission.

As illustrated in FIG. 17, the clutch apparatus 210 includes the output shaft 15, input-side rotary plates 20, output-side rotary plates 22, a clutch housing 30, a clutch center 240, a pressure plate 270, and a stopper plate 300.

As illustrated in FIG. 17, the output shaft 15 includes, in its hollow portion 15H, a push rod 16A and a push member 16B disposed adjacent to the push rod 16A. The hollow portion 15H functions as a clutch oil flow passage. Clutch oil flows through the output shaft 15, i.e., through its hollow portion 15H. The push rod 16A and the push member 16B are provided to be slidable through the hollow portion 15H of the output shaft 15. A first end portion (i.e., a left end portion in FIG. 17) of the push rod 16A is coupled to a clutch operation lever (not illustrated) of the motorcycle such that the push rod 16A slides through the hollow portion 15H in response to an operation performed on the clutch operation lever and thus pushes the push member 16B in a second direction D2. A portion of the push member 16B protrudes out of the output shaft 15 (i.e., in the second direction D2 in this example embodiment) and is coupled to a release bearing 18 provided on the pressure plate 270. The push rod 16A and the push member 16B are each smaller than an inner diameter of the hollow portion 15H, with the result that clutch oil is allowed to flow through the hollow portion 15H.

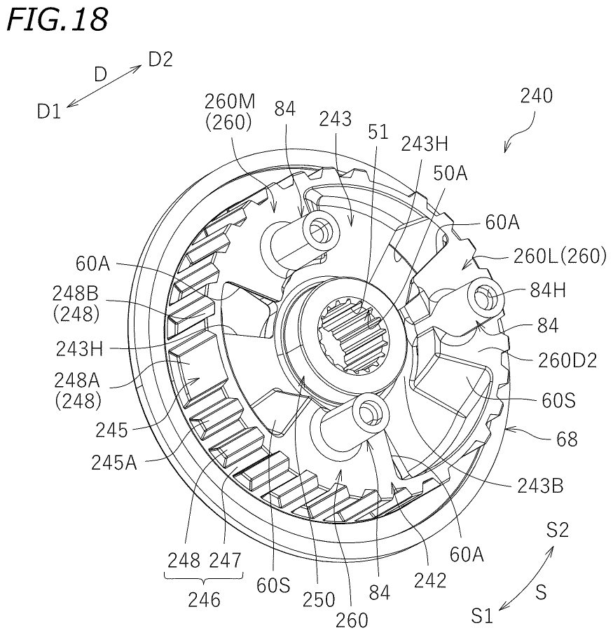

As illustrated in FIG. 17, the clutch center 240 is housed in the clutch housing 30. The clutch center 240 is disposed concentrically with the clutch housing 30. As illustrated in FIG. 18, the clutch center 240 includes a cylindrical body 242 and a center-side flange 68 extending radially outward from an outer peripheral edge of the body 242. The body 242 protrudes in the second direction D2 relative to the center-side flange 68. The clutch center 240 holds some of the output-side rotary plates 22 positioned alternately with the input-side rotary plates 20 in a direction D. The clutch center 240 is rotationally driven together with the output shaft 15.

As illustrated in FIG. 18, the body 242 includes an annular base wall 243, an output shaft holder 250 provided in a central portion of the base wall 243, a center-side outer peripheral wall 245 located radially outward of the base wall 243 and extending in the second direction D2, and center-side cam portions 260 connected to the base wall 243 and the center-side outer peripheral wall 245.

As illustrated in FIG. 18, the output shaft holder 250 has a cylindrical shape. The output shaft holder 250 extends in the direction D. An end of the output shaft holder 250 facing in the second direction D2 is located in a first direction D1 relative to the center-side cam portions 260. The output shaft 15 is coupled to the output shaft holder 250.

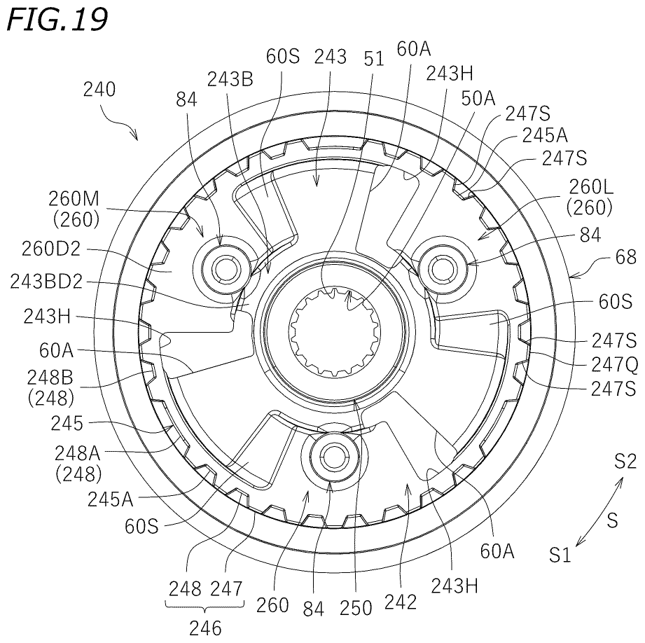

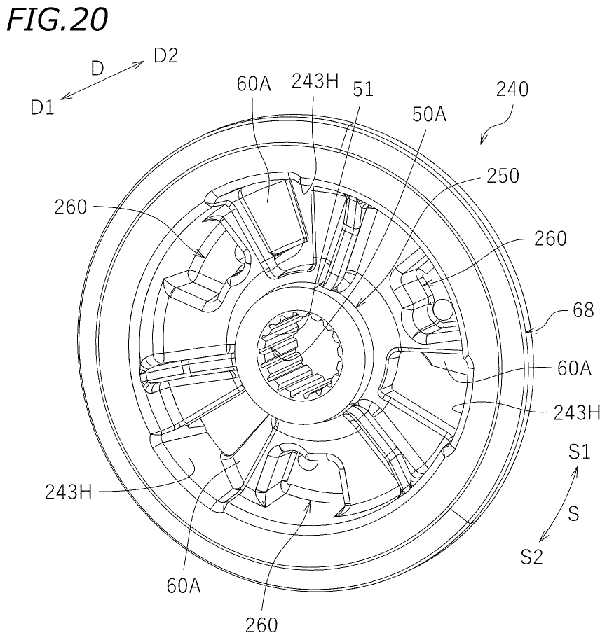

As illustrated in FIGS. 18 and 19, the center-side outer peripheral wall 245 has an annular shape extending in the direction D. An outer peripheral surface 245A of the center-side outer peripheral wall 245 is provided with a center-side spline fitting portion 246. The center-side spline fitting portion 246 includes center-side fitting teeth 247 extending in an axial direction of the clutch center 240 along the outer peripheral surface 245A of the center-side outer peripheral wall 245, and center-side spline grooves 248 each provided between adjacent ones of the center-side fitting teeth 247 and extending in the axial direction of the clutch center 240. The center-side fitting teeth 247 hold the output-side rotary plates 22. The center-side fitting teeth 247 are arranged in a circumferential direction S. The center-side fitting teeth 247 are similar in shape. The center-side fitting teeth 247 protrude radially outward from the outer peripheral surface 245A of the center-side outer peripheral wall 45. When viewed in an axial direction of the output shaft 15, the center-side fitting teeth 247 each include lateral surfaces 247S facing oppositely in the circumferential direction S, and a top surface 247Q connecting radially outer ends of the lateral surfaces 247S to each other. The center-side spline grooves 248 are arranged in the circumferential direction S. The center-side spline grooves 248 include first center-side spline grooves 248A whose lengths in the circumferential direction S are long, and second center-side spline grooves 248B whose lengths in the circumferential direction S are short. When viewed in the axial direction of the output shaft 15, the center-side spline grooves 248 are each defined by the lateral surfaces 247S of the center-side fitting teeth 247 adjacent to each other in the circumferential direction S, and the outer peripheral surface 245A of the center-side outer peripheral wall 245.

The center-side cam portions 260 are each in the shape of a block with cam surfaces that are inclined surfaces included in an assist & slipper (registered trademark) mechanism. The center-side cam portions 260 are provided on the body 242. Ends of the center-side cam portions 260 facing in the second direction D2 are flush with an end of the center-side outer peripheral wall 245 facing in the second direction D2. The center-side cam portions 260 are disposed at equal or substantially equal intervals in the circumferential direction S of the clutch center 240. In the present example embodiment, the number of center-side cam portions 260 included in the clutch center 240 is three. The number of center-side cam portions 260, however, is not limited to three.

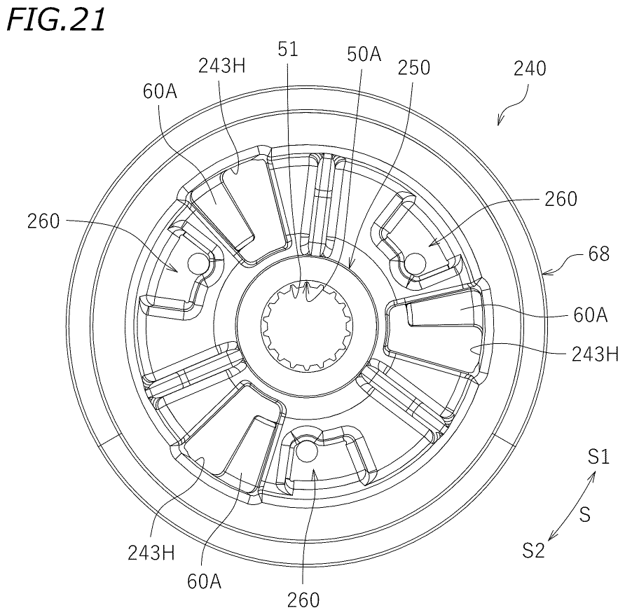

As illustrated in FIGS. 18 and 19, the center-side cam portions 260 are located radially outward relative to the output shaft holder 250. The center-side cam portions 260 include center-side assist cam surfaces 60A (see also FIGS. 20 and 21) and center-side slipper cam surfaces 60S. The center-side assist cam surface 260A of a first center-side cam portion 260L, which is one of the center-side cam portions 260 adjacent to each other in the circumferential direction S, and the center-side slipper cam surface 260S of a second center-side cam portion 260M, which is another one of the center-side cam portions 260 adjacent to each other in the circumferential direction S, are disposed to face each other in the circumferential direction S.

As illustrated in FIGS. 19 and 21, the clutch center 240 includes center-side cam holes 243H each defined through a portion of the base wall 243. The center-side cam holes 243H extend through the base wall 243 in the direction D. The center-side cam holes 243H are located radially outward relative to the output shaft holder 250. The center-side cam holes 243H each extend to the center-side outer peripheral wall 245 from a portion of the base wall 243 located radially outward of the output shaft holder 250. Each center-side cam hole 243H is defined through a portion of the base wall 243 located between the associated center-side cam portions 260 adjacent to each other. Each center-side cam hole 243H is defined through a portion of the base wall 243 located between the center-side assist cam surface 60A and the center-side slipper cam surface 60S of the associated center-side cam portions 260 adjacent to each other. When viewed in the axial direction of the clutch center 240, the center-side assist cam surfaces 60A and portions of the center-side cam holes 243H overlap with each other.

As illustrated in FIGS. 18 and 19, the clutch center 240 includes bosses 84 (the number of which is three in the present example embodiment). The bosses 84 are located radially outward relative to the output shaft holder 250. The bosses 84 extend in the second direction D2 from the base wall 243. The bosses 84 are provided in the center-side cam portions 260. As illustrated in FIG. 17, the bosses 84 are each inserted into an associated one of pressure-side cam holes 273H.

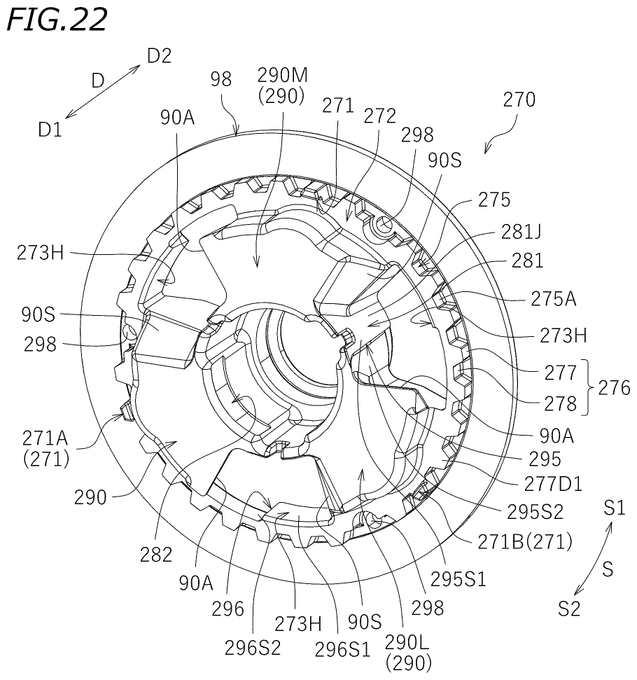

As illustrated in FIG. 17, the pressure plate 270 is housed in the clutch housing 30. The pressure plate 270 is located in the second direction D2 relative to the clutch center 240. The pressure plate 270 is provided to be movable toward or away from the clutch center 240. The pressure plate 270 is rotatable relative to the clutch center 240. The pressure plate 270 is configured to be able to push the input-side rotary plates 20 and the output-side rotary plates 22. As illustrated in FIG. 22, the pressure plate 270 is disposed concentrically with the clutch center 240 and the clutch housing 230. The pressure plate 270 includes a cylindrical body 272 and a pressure-side flange 98 connected to an outer peripheral edge of the body 272 (which is located in the second direction D2) and extending radially outward therefrom. The body 272 protrudes in the first direction D1 relative to the pressure-side flange 98. The pressure plate 270 holds some of the output-side rotary plates 22 positioned alternately with the input-side rotary plates 20.

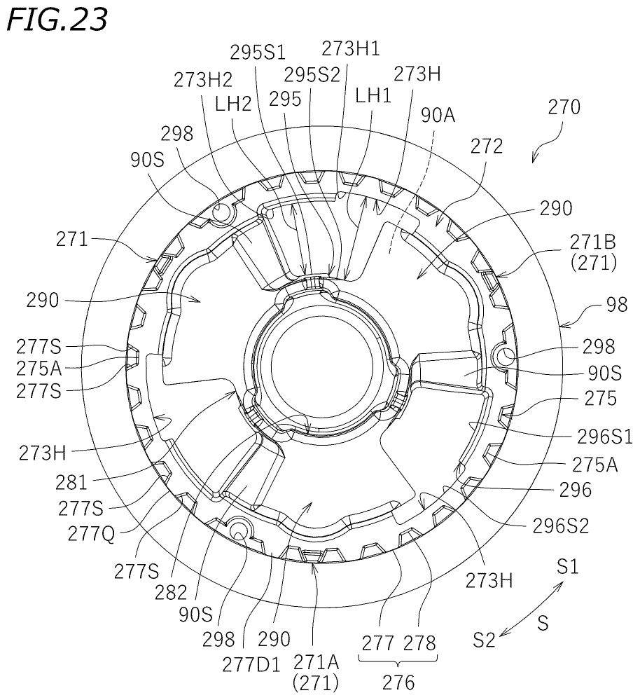

As illustrated in FIGS. 22 and 23, the body 272 includes a tubular portion 281, a fitting hole 282 provided in the tubular portion 281, a pressure-side outer peripheral wall 275 located radially outward relative to the tubular portion 281 and extending in the direction D, and pressure-side cam portions 290 located radially outward of the tubular portion 281 and connected to the pressure-side outer peripheral wall 275.

As illustrated in FIGS. 22 and 23, the body 272 is provided with through holes 298 defined therethrough in the direction D. The through holes 298 are located radially outward relative to the pressure-side outer peripheral wall 275. The through holes 298 are located radially outward of pressure-side slipper cam surfaces 90S. The through holes 298 are located radially inward relative to the pressure-side flange 98. The through holes 298 are each located between adjacent ones of the pressure-side fitting teeth 277.

As illustrated in FIGS. 22 and 23, the fitting hole 282 is provided in an open end of the tubular portion 281 facing in the first direction D1. The output shaft holder 250 of the clutch center 240 is inserted into the fitting hole 282. The output shaft holder 250 is fitted into the fitting hole 282. With the pressure plate 270 assembled to the clutch center 240, the tubular portion 281 is located radially outward of the output shaft holder 250.

As illustrated in FIGS. 22 and 23, the pressure-side outer peripheral wall 275 has an annular shape extending in the direction D. An outer peripheral surface 275A of the pressure-side outer peripheral wall 275 is provided with a pressure-side spline-fitting portion 276. The pressure-side spline-fitting portion 276 includes the pressure-side fitting teeth 277 extending in an axial direction of the pressure plate 270 along the outer peripheral surface 275A of the pressure-side outer peripheral wall 275, and pressure-side spline grooves 278 each provided between adjacent ones of the pressure-side fitting teeth 277 and extending in the axial direction of the pressure plate 270. The pressure-side fitting teeth 277 hold the output-side rotary plates 22. The pressure-side fitting teeth 277 are arranged in the circumferential direction S. The pressure-side fitting teeth 277 are similar in shape. The pressure-side fitting teeth 277 protrude radially outward from the outer peripheral surface 275A of the pressure-side outer peripheral wall 275. When viewed in the axial direction of the output shaft 15, the pressure-side fitting teeth 277 each include lateral surfaces 277S facing oppositely in the circumferential direction S, and a top surface 277Q connecting radially outer ends of the lateral surfaces 277S to each other. In the present example embodiment, the pressure-side fitting teeth 277 and the center-side fitting teeth 247 are similar in external shape when viewed in the axial direction of the output shaft 15. The pressure-side spline grooves 278 are arranged in the circumferential direction S. When viewed in the axial direction of the output shaft 15, the pressure-side spline grooves 278 are each defined by the lateral surfaces 277S of the pressure-side fitting teeth 277 adjacent to each other in the circumferential direction S, and the outer peripheral surface 275A of the pressure-side outer peripheral wall 275.

As illustrated in FIGS. 22 and 23, the pressure plate 270 includes pressure-side protrusions 271. The pressure-side protrusions 271 are provided on an end 277D1 of the pressure-side fitting teeth 277 facing in the first direction D1. The pressure-side protrusions 271 extend in the first direction D1 from the end 277D1 facing in the first direction D1. The pressure-side protrusions 271 are integral with the pressure-side fitting teeth 277. The pressure-side protrusions 271 are arranged in the circumferential direction S. The pressure-side protrusions 271 are provided at equal intervals in the circumferential direction S. The pressure-side protrusions 271 are similar in shape. In this example embodiment, the pressure-side protrusions 271 include, for example, a first pressure-side protrusion 271A and a second pressure-side protrusion 271B. A length of the first pressure-side protrusion 271A in the direction D and a length of the second pressure-side protrusion 271B in the direction D are equal to each other. The length of the first pressure-side protrusion 271A in the direction D and the length of the second pressure-side protrusion 271B in the direction D may be different from each other.

The pressure-side cam portions 290 are each in the shape of a block with cam surfaces that are inclined surfaces included in an assist & slipper (registered trademark) mechanism. The pressure-side cam portions 290 are protruding in the first direction D1 relative to the pressure-side flange 98. The pressure-side cam portions 290 are disposed at equal or substantially equal intervals in the circumferential direction S of the pressure plate 270. In the present example embodiment, the number of pressure-side cam portions 290 included in the pressure plate 270 is three. The number of pressure-side cam portions 290, however, is not limited to three.

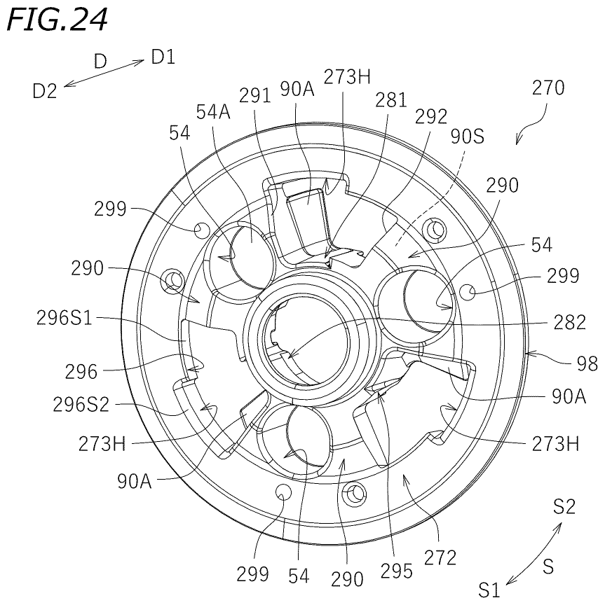

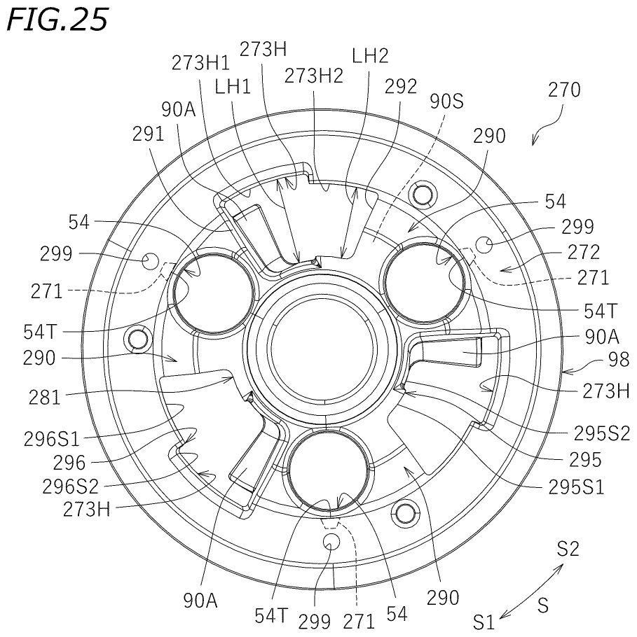

As illustrated in FIGS. 22 and 23, the pressure-side cam portions 290 are located radially outward of the tubular portion 281. The pressure-side cam portions 290 include pressure-side assist cam surfaces 90A (see also FIGS. 24 and 25) and the pressure-side slipper cam surfaces 90S. The pressure-side assist cam surface 90A of a first pressure-side cam portion 290L, which is one of the pressure-side cam portions 290 adjacent to each other in the circumferential direction S, and the pressure-side slipper cam surface 90S of a second pressure-side cam portion 290M, which is another one of the pressure-side cam portions 290 adjacent to each other in the circumferential direction S, are disposed to face each other in the circumferential direction S.

As illustrated in FIGS. 24 and 25, the pressure-side cam portions 290 each include a first corner portion 291 and a second corner portion 292. Each first corner portion 291 defines an open end of the associated pressure-side cam hole 273H (which faces in the second direction D2) and is located on a first side in the circumferential direction S of the pressure plate 270 (i.e., located in a second circumferential direction S2 in this example embodiment) relative to the associated pressure-side cam hole 273H. Each first corner portion 291 is located adjacent to the associated pressure-side assist cam surface 90A. Each first corner portion 291 is provided by rounding an angular corner to form a “radius”. Each second corner portion 292 defines an open end of the associated pressure-side cam hole 273H (which faces in the second direction D2) and is located on a second side in the circumferential direction S of the pressure plate 270 (i.e., located in a first circumferential direction S1 in this example embodiment) relative to the associated pressure-side cam hole 273H. Each second corner portion 292 is located adjacent to the associated pressure-side slipper cam surface 90S. Each second corner portion 292 includes a “sharp corner”with a pointed tip.

As illustrated in FIGS. 23 and 25, the pressure plate 270 includes the pressure-side cam holes 273H each defined through a portion of the body 272. The pressure-side cam holes 273H extend through the body 272 in the direction D. The pressure-side cam holes 273H are located radially outward relative to the fitting hole 282. The pressure-side cam holes 273H each extend to the pressure-side outer peripheral wall 275 from a portion of the body 272 located radially outward of the fitting hole 282. The pressure-side cam holes 273H are each defined through a portion of the body 272 located between the pressure-side cam portions 290 adjacent to each other. The pressure-side cam holes 273H are each defined through a portion of the body 272 located between the pressure-side assist cam surface 90A and the pressure-side slipper cam surface 90S of the pressure-side cam portions 290 adjacent to each other. Each pressure-side cam hole 273H includes a first portion 273H1 located adjacent to the associated pressure-side assist cam surface 90A, and a second portion 273H2 located adjacent to the associated pressure-side slipper cam surface 90S. A radial length LH1 of each first portion 273H1 is longer than a radial length LH2 of each second portion 273H2. When viewed in the axial direction of the pressure plate 270 (i.e., the axial direction of the output shaft 15), the pressure-side assist cam surfaces 90A and portions of the pressure-side cam holes 273H overlap with each other.

As illustrated in FIGS. 22 to 25, the pressure plate 270 includes radially inner stepped portions 295. The radially inner stepped portions 295 are provided on radially outer surfaces 281J of the tubular portion 281. The radially inner stepped portions 295 extend in the direction D. The radially inner stepped portions 295 define portions of the pressure-side cam holes 273H. When viewed in the axial direction of the output shaft 15, regions 295S1 of the radially inner stepped portions 295 situated in the first circumferential direction S1 are located radially outward relative to regions 295S2 of the radially inner stepped portions 295 situated in the second circumferential direction S2.

As illustrated in FIGS. 22 to 25, the pressure plate 270 includes radially outer stepped portions 296. The radially outer stepped portions 296 are provided on radially inner surfaces of the pressure-side outer peripheral wall 275. The radially outer stepped portions 296 extend in the direction D. The radially outer stepped portions 296 define portions of the pressure-side cam holes 273H. When viewed in the axial direction of the output shaft 15, regions 296S1 of the radially outer stepped portions 296 situated in the first circumferential direction S1 are located radially inward relative to regions 296S2 of the radially outer stepped portions 296 situated in the second circumferential direction S2.

As illustrated in FIGS. 24 and 25, the pressure plate 270 includes spring housing portions 54. The spring housing portions 54 are each an example of a housing portion. The spring housing portions 54 are recessed in the first direction D1 from the second direction D2. The spring housing portions 54 are provided in the body 272. More specifically, the spring housing portions 54 are provided in the pressure-side cam portions 290. In the present example embodiment, the number of spring housing portions 54 included in the pressure plate 270 is three. The three spring housing portions 54 are disposed at equal or substantially equal intervals in the circumferential direction S of the pressure plate 270. The number of spring housing portions 54, however, is not limited to three. Each spring housing portion 54 is located in the first circumferential direction S1 relative to the associated pressure-side slipper cam surface 90S. Each spring housing portion 54 is located in the second circumferential direction S2 relative to the associated pressure-side assist cam surface 90A. Each spring housing portion 54 is located in the second circumferential direction S2 relative to the associated first corner portion 291. A bottom wall 54A of each spring housing portion 54 comes into contact with an end 25D1 of an associated one of clutch springs 25, which faces in the first direction D1. A length of each pressure-side cam hole 273H in the circumferential direction S is longer than a length of each spring housing portion 54 in the circumferential direction S. At least portions of the pressure-side protrusions 271 are located radially outward of the spring housing portions 54. The pressure-side protrusions 271 are located radially outward of radially outer ends 54T of the spring housing portions 54.

As illustrated in FIGS. 24 and 25, the pressure plate 270 includes recesses 299 provided in the pressure-side flange 98. The recesses 299 are located radially outward of the spring housing portions 54. The recesses 299 are recessed in the first direction D1 from the second direction D2. The recesses 299 are recessed to, for example, a depth of between about 0.1 mm and about 0.5 mm, inclusive, measured from a surface of the pressure-side flange 98 facing in the second direction D2. The recesses 299 may be recessed to a depth greater than about 0 mm and less than about 0.1 mm, measured from the surface of the pressure-side flange 98 facing in the second direction D2. At least a portion of each pressure-side protrusion 271 is located between the associated spring housing portion 54 and the associated recess 299 in a radial direction.

As illustrated in FIG. 17, the stopper plate 300 is provided to be able to come into contact with the pressure plate 270. The stopper plate 300 is a component to prevent the pressure plate 270 from moving away from the clutch center 240 in the second direction D2 by a predetermined distance or more. An end 25D2 of each clutch spring 25 facing in the second direction D2 comes into contact with the stopper plate 300. The stopper plate 300 is secured to the clutch center 240 with bolts 28. The stopper plate 300 rotates together with the clutch center 240.

As illustrated in FIG. 26, when viewed in the axial direction of the output shaft 15, a center-side annular portion 249 having an annular shape at least partially overlaps with a pressure-side annular portion 279 having an annular shape. In the present example embodiment, an entirety of the center-side annular portion 249 overlaps with an entirety of the pressure-side annular portion 279. When viewed in the axial direction of the output shaft 15, the center-side annular portion 249 is bounded in a radial direction by a center-side tooth tip circle 249A passing through tooth tips 247T (i.e., the top surfaces 247Q) that are radially outermost portions of the center-side fitting teeth 247, and a center-side tooth bottom circle 249B passing through tooth bottoms 247B that are radially innermost portions of the center-side fitting teeth 247. The tooth bottoms 247B are continuous with the outer peripheral surface 245A of the center-side outer peripheral wall 245 and correspond in position to the outer peripheral surface 245A in the radial direction. When viewed in the axial direction of the output shaft 15, the pressure-side annular portion 279 is bounded in the radial direction by a pressure-side tooth tip circle 279A passing through tooth tips 277T (i.e., the top surfaces 277Q) that are radially outermost portions of the pressure-side fitting teeth 277, and a pressure-side tooth bottom circle 279B passing through tooth bottoms 277B that are radially innermost portions of the pressure-side fitting teeth 277. The tooth bottoms 277B are continuous with the outer peripheral surface 275A of the pressure-side outer peripheral wall 275 and correspond in position to the outer peripheral surface 275A in the radial direction. In FIG. 26, the center-side fitting teeth 247 and the center-side spline grooves 248 are represented by broken lines, and the pressure-side fitting teeth 277 and the pressure-side spline grooves 278 are represented by solid lines.

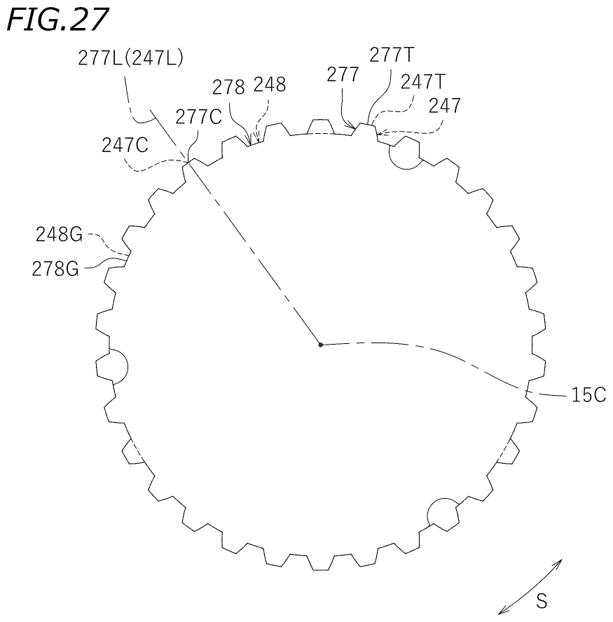

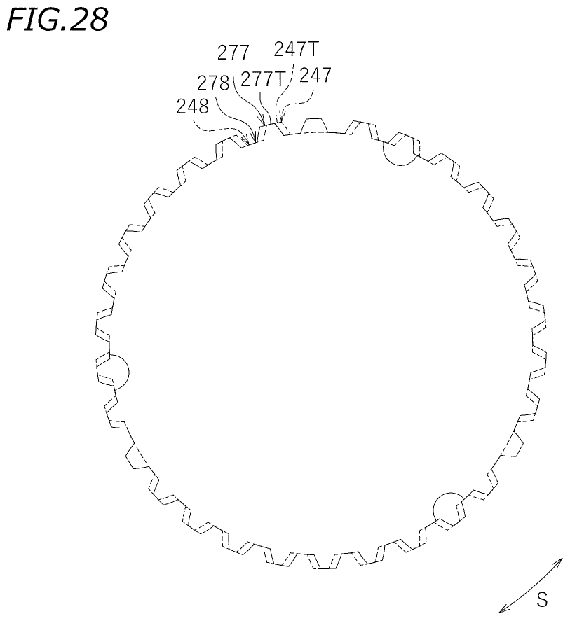

As illustrated in FIGS. 27 and 28, when viewed in the axial direction of the output shaft 15, at least portions of the pressure-side fitting teeth 277 overlap with the center-side fitting teeth 247. When viewed in the axial direction of the output shaft 15, at least portions of the tooth tips 277T of the pressure-side fitting teeth 277 overlap with the tooth tips 247T of the center-side fitting teeth 247. In the example illustrated in FIG. 27, an entirety of each pressure-side fitting tooth 277 overlaps with an entirety of an associated one of the center-side fitting teeth 247 when viewed in the axial direction of the output shaft 15. When viewed in the axial direction of the output shaft 15, an entirety of the tooth tip 277T of each pressure-side fitting tooth 277 overlaps with an entirety of the tooth tip 247T of an associated one of the center-side fitting teeth 247. When viewed in the axial direction of the output shaft 15, a center-side central line 247L passing through a center 247C of each center-side fitting tooth 247 in the circumferential direction S and a center 15C of the output shaft 15 overlaps with a pressure-side central line 277L passing through a center 277C of an associated one of the pressure-side fitting teeth 277 in the circumferential direction S and the center 15C of the output shaft 15. In the example illustrated in FIG. 28, a portion of each pressure-side fitting tooth 277 overlaps with a portion of an associated one of the center-side fitting teeth 247 when viewed in the axial direction of the output shaft 15. When viewed in the axial direction of the output shaft 15, a portion of the tooth tip 277T of each pressure-side fitting tooth 277 overlaps with a portion of the tooth tip 247T of an associated one of the center-side fitting teeth 247. As illustrated in FIGS. 27 and 28, at least portions of the pressure-side spline grooves 278 overlap with the center-side spline grooves 248 when viewed in the axial direction of the output shaft 15. In the example illustrated in FIG. 27, an entirety of each pressure-side spline groove 278 overlaps with an entirety of an associated one of the center-side spline grooves 248 when viewed in the axial direction of the output shaft 15. In the example illustrated in FIG. 28, a portion of each pressure-side spline groove 278 overlaps with a portion of an associated one of the center-side spline grooves 248 when viewed in the axial direction of the output shaft 15.

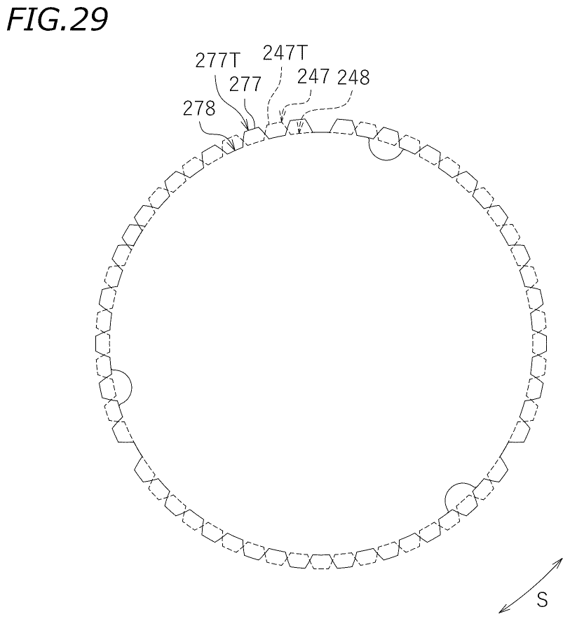

As illustrated in FIG. 29, the pressure-side fitting teeth 277 do not overlap with the center-side fitting teeth 247 when viewed in the axial direction of the output shaft 15. In the example illustrated in FIG. 29, the entirety of the tooth tip 277T of each pressure-side fitting tooth 277 does not overlap with the entirety of the tooth tip 247T of an associated one of the center-side fitting teeth 247 when viewed in the axial direction of the output shaft 15. As illustrated in FIG. 29, portions of the pressure-side spline grooves 278 do not overlap with the center-side spline grooves 248 when viewed in the axial direction of the output shaft 15.

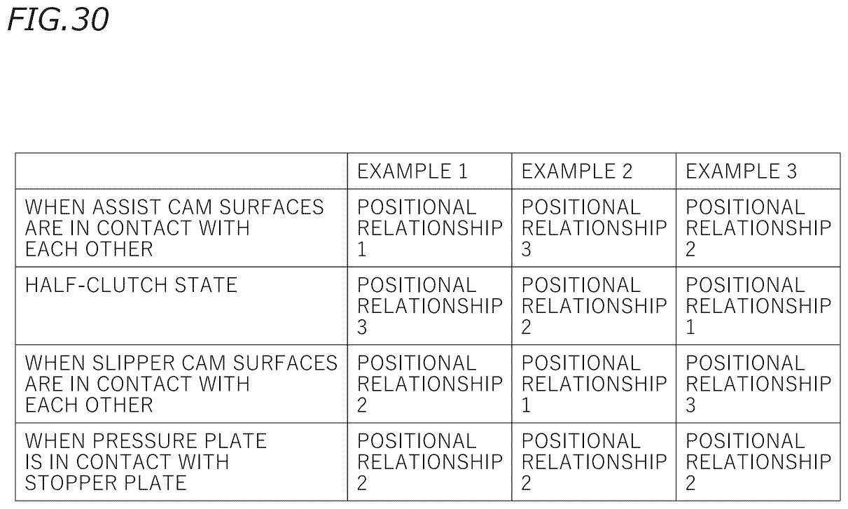

The positional relationship between the center-side fitting teeth 247 and the pressure-side fitting teeth 277 when viewed in the axial direction of the output shaft 15 varies depending on the positional relationship of the pressure plate 270 with respect to the clutch center 240. The positional relationship between the center-side fitting teeth 247 and the pressure-side fitting teeth 277 when viewed in the axial direction of the output shaft 15 may vary, for example, under the following conditions when the center-side assist cam surfaces 60A and the pressure-side assist cam surfaces 90A are in contact with each other, when the half-clutch state occurs, when the center-side slipper cam surfaces 60S and the pressure-side slipper cam surfaces 90S are in contact with each other, and when the pressure plate 270 is in contact with the stopper plate 300. Assuming that the positional relationship illustrated in FIG. 27 is Positional Relationship 1, the positional relationship illustrated in FIG. 28 is Positional Relationship 2, and the positional relationship illustrated in FIG. 29 is Positional Relationship 3, the positional relationship between the center-side fitting teeth 247 and the pressure-side fitting teeth 277 when viewed in the axial direction of the output shaft 15 may be one of the relationships illustrated in FIG. 30. As illustrated in FIG. 30, in Example 1, for instance, Positional Relationship 1 (FIG. 27) may be established when the center-side assist cam surfaces 60A and the pressure-side assist cam surfaces 90A are in contact with each other, Positional Relationship 3 (FIG. 29) may be established when the half-clutch state occurs, Positional Relationship 2 (FIG. 28) may be established when the center-side slipper cam surfaces 60S and the pressure-side slipper cam surfaces 90S are in contact with each other, and Positional Relationship (FIG. 28) may be established when the pressure plate 270 is in contact with the stopper plate 300.

During at least part of a period including a state in which the center-side assist cam surfaces 60A and the pressure-side assist cam surfaces 90A are in contact with each other, a state in which the center-side slipper cam surfaces 60S and the pressure-side slipper cam surfaces 90S are in contact with each other, and a transition from the former state to the latter state, at least portions of the pressure-side fitting teeth 277 may overlap with the center-side fitting teeth 247 when viewed in the axial direction of the output shaft 15. With the center-side assist cam surfaces 60A and the pressure-side assist cam surfaces 90A in contact with each other, at least portions of the pressure-side fitting teeth 277 may overlap with the center-side fitting teeth 247 when viewed in the axial direction of the output shaft 15. Throughout the period including the state in which the center-side assist cam surfaces 60A and the pressure-side assist cam surfaces 90A are in contact with each other, the state in which the center-side slipper cam surfaces 60S and the pressure-side slipper cam surfaces 90S are in contact with each other, and the transition from the former state to the latter state, at least portions of the pressure-side fitting teeth 277 may overlap with the center-side fitting teeth 247 when viewed in the axial direction of the output shaft 15.

During at least part of a period including a driving state in which the pressure plate 270 is located closest to the clutch center 240, a driving state in which the pressure plate 270 is located farthest away from the clutch center 240, and a transition from the former driving state to the latter driving state, at least portions of the pressure-side fitting teeth 277 may overlap with the center-side fitting teeth 247 when viewed in the axial direction of the output shaft 15. Throughout the period including the driving state in which the pressure plate 270 is located closest to the clutch center 240, the driving state in which the pressure plate 270 is located farthest away from the clutch center 240, and the transition from the former driving state to the latter driving state, at least portions of the pressure-side fitting teeth 277 may overlap with the center-side fitting teeth 247 when viewed in the axial direction of the output shaft 15.

During at least part of the half-clutch state, at least portions of the pressure-side fitting teeth 277 may overlap with the center-side fitting teeth 247 when viewed in the axial direction of the output shaft 15. Throughout the half-clutch state, at least portions of the pressure-side fitting teeth 277 may overlap with the center-side fitting teeth 247 when viewed in the axial direction of the output shaft 15.

During part of the period including the state in which the center-side assist cam surfaces 60A and the pressure-side assist cam surfaces 90A are in contact with each other, the state in which the center-side slipper cam surfaces 60S and the pressure-side slipper cam surfaces 90S are in contact with each other, and the transition from the former state to the latter state, the center-side central line 247L (see FIG. 27) passing through the center 247C of each center-side fitting tooth 247 in the circumferential direction S and the center 15C of the output shaft 15 may overlap with the pressure-side central line 277L passing through the center 277C of the associated pressure-side fitting tooth 277 in the circumferential direction S and the center 15C of the output shaft 15 when viewed in the axial direction of the output shaft 15. With the center-side assist cam surfaces 60A and the pressure-side assist cam surfaces 90A in contact with each other, the center-side central line 247L may overlap with the pressure-side central line 277L when viewed in the axial direction of the output shaft 15.

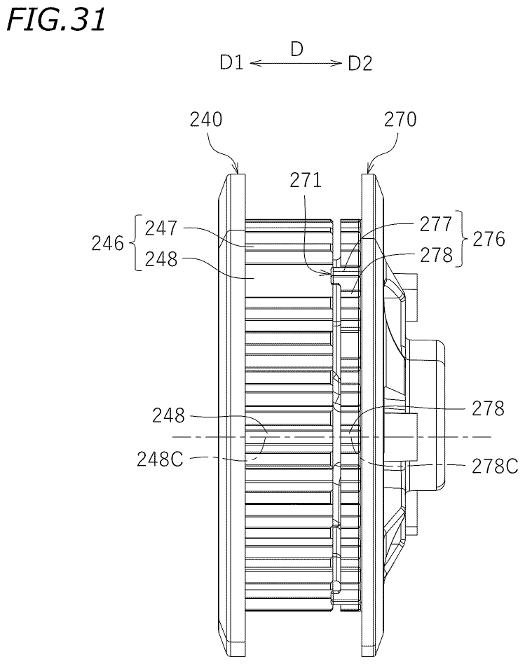

As illustrated in FIG. 31, during at least part of the period including the driving state in which the pressure plate 270 is located closest to the clutch center 240, the driving state in which the pressure plate 270 is located farthest away from the clutch center 240, and the transition from the former driving state to the latter driving state, a central line 248C of each center-side spline groove 248 extending in the axial direction of the output shaft 15 and a central line 278C of the associated pressure-side spline groove 278 extending in the axial direction of the output shaft 15 are collinear when viewed in the radial direction of the output shaft 15, and a radially inner surface 248G of each center-side spline groove 248 and a radially inner surface 278G of the associated pressure-side spline groove 278 are coplanar when viewed in the axial direction of the output shaft 15 (see FIG. 27).

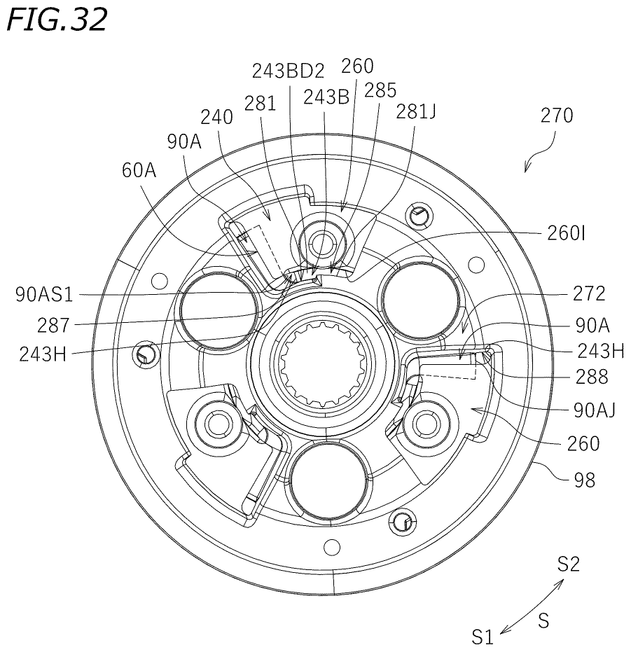

As illustrated in FIG. 32, with the center-side assist cam surfaces 60A and the pressure-side assist cam surfaces 90A in contact with each other, first clearances 287 that extend through the clutch center 240 and the pressure plate 270 in the direction D and that overlap with the center-side cam holes 243H are disposed in the first circumferential direction S1 relative to ends 90AS1 of the pressure-side assist cam surfaces 90A (which face in the first circumferential direction S1) when viewed in the axial direction of the output shaft 15 (e.g., when viewed in the first direction D1 from the second direction D2). Each first clearance 287 is defined by the associated end 90AS1, the associated center-side cam portion 260, and a center-side bottom wall 243B. As illustrated in FIGS. 18 and 19, the center-side bottom wall 243B is a portion of the base wall 243 and is located radially outward relative to the output shaft holder 250 and located radially inward relative to the center-side cam portions 260. The center-side bottom wall 243B is located in the first direction D1 relative to ends 260D2 of the center-side cam portions 260 facing in the second direction D2.

As illustrated in FIG. 32, with the center-side assist cam surfaces 60A and the pressure-side assist cam surfaces 90A in contact with each other, recesses 285 recessed in the first direction D1 are defined by the clutch center 240 and the pressure plate 270. Each recess 285 is defined by a radially inner surface 260I of the associated center-side cam portion 260, a surface 243BD2 of the center-side bottom wall 243B facing in the second direction D2, and a radially outer surface 281J of the tubular portion 281. The recesses 285 are located in the first circumferential direction S1 relative to the first clearances 287.

As illustrated in FIG. 32, with the center-side assist cam surfaces 60A and the pressure-side assist cam surfaces 90A in contact with each other, second clearances 288 that extend through the clutch center 240 and the pressure plate 270 in the direction D and that overlap with the center-side cam holes 243H are disposed radially outward of the pressure-side assist cam surfaces 90A when viewed in the axial direction of the output shaft 15. Each second clearance 288 is defined by a radially outer end 90AJ of the associated pressure-side assist cam surface 90A, the associated center-side cam portion 260, and the body 272.

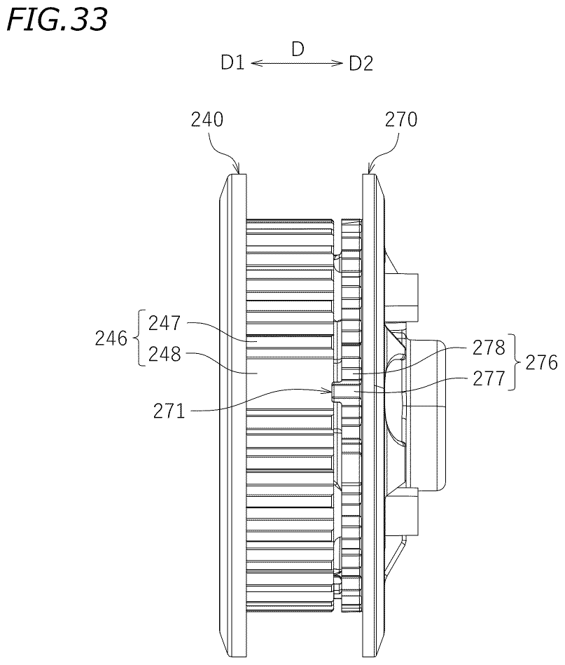

As illustrated in FIG. 33, during at least part of the half-clutch state, at least a portion of each pressure-side protrusion 271 overlaps with the associated center-side spline groove 248 when viewed in the radial direction of the output shaft 15. Throughout the half-clutch state, at least a portion of each pressure-side protrusion 271 may overlap with the associated center-side spline groove 248 when viewed in the radial direction of the output shaft 15. During the clutch-disengaged state, at least a portion of each pressure-side protrusion 271 may overlap with the associated center-side spline groove 248 when viewed in the radial direction of the output shaft 15. During at least part of (e.g., throughout) the state in which the center-side slipper cam surfaces 60S and the pressure-side slipper cam surfaces 90S are in contact with each other, at least a portion of each pressure-side protrusion 271 may overlap with the associated center-side spline groove 248 when viewed in the radial direction of the output shaft 15. With the center-side assist cam surfaces 60A and the pressure-side assist cam surfaces 90A in contact with each other, at least a portion of each pressure-side protrusion 271 may overlap with the associated center-side spline groove 248 when viewed in the radial direction of the output shaft 15. With the pressure plate 270 and the stopper plate 300 in contact with each other, at least a portion of each pressure-side protrusion 271 may overlap with the associated center-side spline groove 248 when viewed in the radial direction of the output shaft 15. The state illustrated in FIG. 33 in which a portion of each pressure-side protrusion 271 overlaps with the associated center-side spline groove 248 may be an example of each of the states mentioned above.

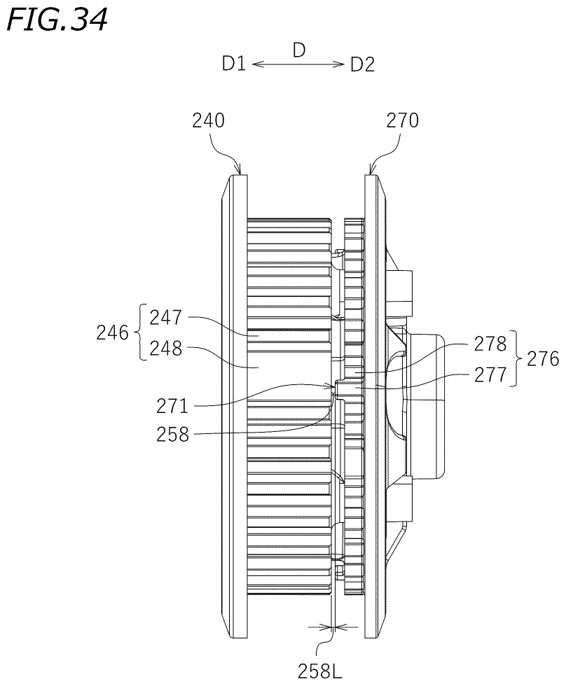

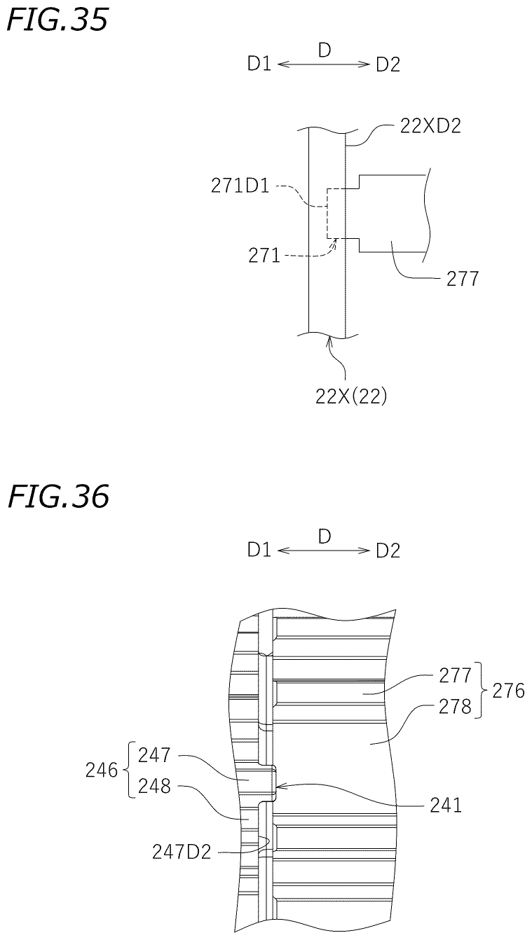

As illustrated in FIG. 34, with the pressure plate 270 and the stopper plate 300 in contact with each other, a clearance 258 may be created between each pressure-side protrusion 271 and the clutch center 240 in the direction D when viewed in the radial direction of the output shaft 15. A length 258L of each clearance 258 in the direction D is shorter than a length 22L (see FIG. 17) of each output-side rotary plate 22 in the direction D. As illustrated in FIG. 35, assuming that the output-side rotary plate 22 located farthest in the first direction D1 among those held by the pressure-side protrusions 271, with the pressure plate 270 located closest to the clutch center 240, is defined as an “outermost output-side rotary plate 22X”, a surface 22XD2 of the outermost output-side rotary plate 22X facing in the second direction D2 is located in the second direction D2 relative to an end 271D1 of each pressure-side protrusion 271 facing in the first direction D1, with the pressure plate 270 and the stopper plate 300 in contact with each other.

In the foregoing example embodiment, the pressure plate 270 includes the pressure-side protrusions 271 and is configured such that during at least part of the half-clutch state, for example, at least a portion of each pressure-side protrusion 271 overlaps with the associated center-side spline groove 248 when viewed in the radial direction of the output shaft 15. The present invention, however, is not limited to this arrangement. In one example, the clutch center 240 may include center-side protrusions 241, and as illustrated in FIG. 36, the clutch center 240 may be configured such that during at least part of the half-clutch state, for example, at least a portion of each center-side protrusion 241 may overlap with the associated pressure-side spline groove 278 when viewed in the radial direction of the output shaft 15. The center-side protrusions 241 are provided on an end 247D2 of the center-side fitting teeth 247 facing in the second direction D2. The center-side protrusions 241 extend in the second direction D2 from the end 247D2 facing in the second direction D2. A positional relationship between the center-side protrusions 241 and the pressure-side spline grooves 278 may be similar to that between the pressure-side protrusions 271 and the center-side spline grooves 248. Alternatively, the clutch center 240 may include the center-side protrusions 241, the pressure plate 270 may include the pressure-side protrusions 271, and the clutch center 240 and the pressure plate 270 may be configured such that during at least one of states (a) to (f) described below, at least portions of the center-side protrusions 241 overlap with the pressure-side spline grooves 278 and at least portions of the pressure-side protrusions 271 overlap with the center-side spline grooves 248 when viewed in the radial direction of the output shaft 15. The state (a) is a state corresponding to at least part of a period during which the half-clutch state occurs. The state (b) is a state corresponding to the entire period during which the half-clutch state occurs. The state (c) is the clutch-disengaged state. The state (d) is the state in which the center-side slipper cam surfaces 60S and the pressure-side slipper cam surfaces 90S are in contact with each other. The state (e) is the state in which the center-side assist cam surfaces 60A and the pressure-side assist cam surfaces 90A are in contact with each other. The state (f) is the state in which the pressure plate 270 and the stopper plate 300 are in contact with each other. A length of each center-side protrusion 241 in the direction D and a length of each pressure-side protrusion 271 in the direction D may be equal to each other or may be different from each other.

In the clutch apparatus 210 according to the present example embodiment, during at least part of the half-clutch state, at least portions of the pressure-side protrusions 271 overlap with the center-side spline grooves 248 when viewed in the radial direction of the output shaft 15. During at least part of the half-clutch state, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, during the clutch-disengaged state, at least portions of the pressure-side protrusions 271 may overlap with the center-side spline grooves 248 when viewed in the radial direction of the output shaft 15. During the clutch-disengaged state, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, with the center-side slipper cam surfaces 60S and the pressure-side slipper cam surfaces 90S in contact with each other, at least portions of the pressure-side protrusions 271 may overlap with the center-side spline grooves 248 when viewed in the radial direction of the output shaft 15. With the center-side slipper cam surfaces 60S and the pressure-side slipper cam surfaces 90S in contact with each other, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, with the pressure plate 270 and the stopper plate 300 in contact with each other, at least portions of the pressure-side protrusions 271 may overlap with the center-side spline grooves 248 when viewed in the radial direction of the output shaft 15. With the pressure plate 270 and the stopper plate 300 in contact with each other, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, with the pressure plate 270 and the stopper plate 300 in contact with each other, the clearance 258 may be created between each pressure-side protrusion 271 and the clutch center 240 in the direction D when viewed in the radial direction of the output shaft 15, and the length 258L of each clearance 258 in the direction D may be shorter than the length 22L of each output-side rotary plate 22 in the direction D. With the pressure plate 270 and the stopper plate 300 in contact with each other, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, with the pressure plate 270 and the stopper plate 300 in contact with each other, the surface 22XD2 of the outermost output-side rotary plate 22X facing in the second direction D2 may be located in the second direction D2 relative to the end 271 D1 of each pressure-side protrusion 271 facing in the first direction D1. With the pressure plate 270 and the stopper plate 300 in contact with each other, this example embodiment would be able to prevent the output-side rotary plates 22, which are held by the pressure-side fitting teeth 277 and the center-side fitting teeth 247, from being disengaged from the pressure-side fitting teeth 277 and the center-side fitting teeth 247 if the clearance 258 is created between each pressure-side protrusion 271 and the clutch center 240.

In the clutch apparatus 210 according to the present example embodiment, at least portions of the pressure-side protrusions 271 are located radially outward of the spring housing portions 54. Although a large force is applied through the output-side rotary plates 22 to portions of the pressure-side protrusions 271 adjacent to their roots during rotation of the pressure plate 270, this example embodiment involves providing the spring housing portions 54 adjacent to the roots of the pressure-side protrusions 271 and thus increases their rigidity, resulting in enhanced durability of the pressure plate 270.

In the clutch apparatus 210 according to the present example embodiment, the pressure-side protrusions 271 are located radially outward of the radially outer ends 54T of the spring housing portions 54. Although a large force is applied through the output-side rotary plates 22 to the portions of the pressure-side protrusions 271 adjacent to their roots during rotation of the pressure plate 270, this example embodiment involves providing the spring housing portions 54 adjacent to the roots of the pressure-side protrusions 271 and thus increases their rigidity, resulting in enhanced durability of the pressure plate 270.

In the clutch apparatus 210 according to the present example embodiment, the length of the first pressure-side protrusion 271A in the direction D and the length of the second pressure-side protrusion 271B in the direction D may be different from each other. This example embodiment does not require increasing the lengths of all of the pressure-side protrusions 271 and is thus able to prevent the output-side rotary plates 22 from being disengaged from the pressure-side fitting teeth 277 and the center-side fitting teeth 247, while limiting a weight increase caused by providing the pressure-side protrusions 271.

In the clutch apparatus 210 according to the present example embodiment, throughout the half-clutch state, at least portions of the pressure-side protrusions 271 may overlap with the center-side spline grooves 248 when viewed in the radial direction of the output shaft 15. Throughout the half-clutch state, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, with the center-side assist cam surfaces 60A and the pressure-side assist cam surfaces 90A in contact with each other, at least portions of the pressure-side protrusions 271 overlap with the center-side spline grooves 248 when viewed in the radial direction of the output shaft 15. With the center-side assist cam surfaces 60A and the pressure-side assist cam surfaces 90A in contact with each other, this example embodiment is able to prevent the output-side rotary plates 22, which are held by the pressure-side fitting teeth 277 and the center-side fitting teeth 247, from being disengaged from the pressure-side fitting teeth 277 and the center-side fitting teeth 247.

In the clutch apparatus 210 according to the present example embodiment, during at least part of the period including the driving state in which the pressure plate 270 is located closest to the clutch center 240, the driving state in which the pressure plate 270 is located farthest away from the clutch center 240, and the transition from the former driving state to the latter driving state, the central line 248C of each center-side spline groove 248 extending in the axial direction of the output shaft 15 and the central line 278C of the associated pressure-side spline groove 278 extending in the axial direction of the output shaft 15 may be collinear when viewed in the radial direction of the output shaft 15, and the radially inner surface 248G of each center-side spline groove 248 and the radially inner surface 278G of the associated pressure-side spline groove 278 may be coplanar when viewed in the axial direction of the output shaft 15. In this example embodiment, clutch oil stored in the pressure-side spline grooves 278 flows to the center-side spline grooves 248, and clutch oil stored in the center-side spline grooves 248 flows to the pressure-side spline grooves 278. This example embodiment thus enables effective supply of clutch oil to the center-side fitting teeth 247 and the pressure-side fitting teeth 277, which are respectively included in the clutch center 240 and the pressure plate 270 and which hold the output-side rotary plates 22.

The example embodiments of the present invention have been described thus far. The foregoing example embodiments, however, are only illustrative. The present invention may be embodied in various other forms.

In each of the foregoing example embodiments, the clutch centers 40 and 240 and the pressure plates 70 and 270 are each configured to hold the output-side rotary plates 22. The present invention, however, is not limited to this configuration. In one example, the clutch centers 40 and 240 may hold all of the output-side rotary plates 22, and the pressure plates 70 and 270 may hold no output-side rotary plates 22. In another example, the pressure plates 70 and 270 may hold all of the output-side rotary plates 22, and the clutch centers 40 and 240 may hold no output-side rotary plates 22.

In each of the foregoing example embodiments, the center-side cam portions 60 and 260 include the center-side assist cam surfaces 60A and the center-side slipper cam surfaces 60S. Alternatively, the center-side cam portions 60 and 260 may include either the center-side assist cam surfaces 60A or the center-side slipper cam surfaces 60S. In each of the foregoing example embodiments, the pressure-side cam portions 90 and 290 include the pressure-side assist cam surfaces 90A and the pressure-side slipper cam surfaces 90S. Alternatively, the pressure-side cam portions 90 and 290 may include either the pressure-side assist cam surfaces 90A or the pressure-side slipper cam surfaces 90S. In one example, the cam surfaces of the center-side cam portions 60 and 260 may include the center-side assist cam surfaces 60A, and the cam surfaces of the pressure-side cam portions 90 and 290 may include the pressure-side assist cam surfaces 90A. In another example, the cam surfaces of the center-side cam portions 60 and 260 may include the center-side slipper cam surfaces 60S, and the cam surfaces of the pressure-side cam portions 90 and 290 may include the pressure-side slipper cam surfaces 90S.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft; and
a pressure plate movable toward or away from the clutch center and configured to hold a remaining one or more of the output-side rotary plates and to push the input-side rotary plates and the output-side rotary plates; wherein
the clutch center includes:
a center-side outer peripheral wall having an annular shape extending in a movement direction, where a direction in which the pressure plate is movable toward and away from the clutch center is the movement direction;
center-side fitting teeth holding the output-side rotary plates, protruding outward in a radial direction from an outer peripheral surface of the center-side outer peripheral wall, and arranged in a circumferential direction, and center-side spline grooves each provided between adjacent ones of the center-side fitting teeth;
the pressure plate includes:
a pressure-side outer peripheral wall having an annular shape extending in the movement direction;
pressure-side fitting teeth holding the output-side rotary plates, protruding outward in the radial direction from an outer peripheral surface of the pressure-side outer peripheral wall, and arranged in the circumferential direction; and
pressure-side spline grooves each provided between adjacent ones of the pressure-side fitting teeth;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction;
where a direction in which the pressure plate is movable toward the clutch center is a first direction and a direction in which the pressure plate is movable away from the clutch center is a second direction, an end of the center-side fitting teeth facing in the second direction is provided with center-side protrusions extending in the second direction; and
during at least part of a half-clutch state, at least portions of the center-side protrusions overlap with the pressure-side spline grooves when viewed in the radial direction of the output shaft.

2. The clutch apparatus according to claim 1, wherein during a clutch-disengaged state, at least portions of the center-side protrusions overlap with the pressure-side spline grooves when viewed in the radial direction of the output shaft.

3. The clutch apparatus according to claim 1, wherein
the clutch center includes center-side cam portions including center-side slipper cam surfaces to, upon rotation of the clutch center relative to the pressure plate, move the pressure plate away from the clutch center to reduce a pushing force for the input-side rotary plates and the output-side rotary plates;
the pressure plate includes pressure-side cam portions including pressure-side slipper cam surfaces to move the pressure plate away from the clutch center to reduce the pushing force for the input-side rotary plates and the output-side rotary plates; and
during at least part of a state in which the center-side slipper cam surfaces and the pressure-side slipper cam surfaces are in contact with each other, at least portions of the center-side protrusions overlap with the pressure-side spline grooves when viewed in the radial direction of the output shaft.

4. The clutch apparatus according to claim 3, wherein throughout the state in which the center-side slipper cam surfaces and the pressure-side slipper cam surfaces are in contact with each other, at least portions of the center-side protrusions overlap with the pressure-side spline grooves when viewed in the radial direction of the output shaft.

5. The clutch apparatus according to claim 1, further comprising a stopper plate secured to the pressure plate to come into contact with the clutch center and to prevent the pressure plate from moving away from the clutch center in the second direction by a predetermined distance or more; wherein
with the clutch center and the stopper plate in contact with each other, at least portions of the center-side protrusions overlap with the pressure-side spline grooves when viewed in the radial direction of the output shaft.

6. The clutch apparatus according to claim 1, further comprising a stopper plate secured to the pressure plate to come into contact with the clutch center and to prevent the pressure plate from moving away from the clutch center in the second direction by a predetermined distance or more; wherein
with the clutch center and the stopper plate in contact with each other, a clearance is created between each of the center-side protrusions and the pressure plate in the movement direction when viewed in the radial direction of the output shaft; and
a length of the clearance in the movement direction is shorter than a length of each of the output-side rotary plates in the movement direction.

7. The clutch apparatus according to claim 1, further comprising a stopper plate secured to the pressure plate to come into contact with the clutch center and to prevent the pressure plate from moving away from the clutch center in the second direction by a predetermined distance or more; wherein
with the clutch center and the stopper plate in contact with each other, a clearance is created between each of the center-side protrusions and the pressure plate in the movement direction when viewed in the radial direction of the output shaft; and
where the output-side rotary plate located farthest in the second direction among those held by the center-side fitting teeth, with the pressure plate located closest to the clutch center, is an outermost output-side rotary plate, a surface of the outermost output-side rotary plate facing in the first direction is located in the first direction relative to ends of the center-side protrusions facing in the second direction, with the clutch center and the stopper plate in contact with each other.

8. The clutch apparatus according to claim 1, wherein the clutch center includes a housing portion recessed in the second direction from the first direction and in which a clutch spring to urge the pressure plate in the first direction is housed; and
at least portions of the center-side protrusions are located outward of the housing portion in the radial direction.

9. The clutch apparatus according to claim 8, wherein the center-side protrusions are located outward of a radially outer end of the housing portion in the radial direction.

10. The clutch apparatus according to claim 1, wherein
the center-side protrusions include a first center-side protrusion and a second center-side protrusion; and
a length of the first center-side protrusion in the movement direction and a length of the second center-side protrusion in the movement direction are different from each other.

11. The clutch apparatus according to claim 1, wherein throughout the half-clutch state, at least portions of the center-side protrusions overlap with the pressure-side spline grooves when viewed in the radial direction of the output shaft.

12. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft; and
a pressure plate movable toward or away from the clutch center and configured to hold a remaining one or more output-side rotary plates and to push the input-side rotary plates and the output-side rotary plates; wherein
the clutch center includes:
a center-side outer peripheral wall having an annular shape extending in a movement direction, where a direction in which the pressure plate is movable toward and away from the clutch center is the movement direction;
center-side fitting teeth holding the output-side rotary plates, protruding outward in a radial direction from an outer peripheral surface of the center-side outer peripheral wall, and arranged in a circumferential direction; and
center-side spline grooves each provided between adjacent ones of the center-side fitting teeth;
the pressure plate includes:
a pressure-side outer peripheral wall having an annular shape extending in the movement direction;
pressure-side fitting teeth holding the output-side rotary plates, protruding outward in the radial direction from an outer peripheral surface of the pressure-side outer peripheral wall, and arranged in the circumferential direction; and
pressure-side spline grooves each provided between adjacent ones of the pressure-side fitting teeth;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction;
where a direction in which the pressure plate is movable toward the clutch center is a first direction and a direction in which the pressure plate is movable away from the clutch center is a second direction, an end of the pressure-side fitting teeth facing in the first direction is provided with pressure-side protrusions extending in the first direction; and
during at least part of a half-clutch state, at least portions of the pressure-side protrusions overlap with the center-side spline grooves when viewed in the radial direction of the output shaft.

13. The clutch apparatus according to claim 12, wherein during a clutch-disengaged state, at least portions of the pressure-side protrusions overlap with the center-side spline grooves when viewed in the radial direction of the output shaft.

14. The clutch apparatus according to claim 12, wherein
the clutch center includes center-side cam portions including center-side slipper cam surfaces to, upon rotation of the clutch center relative to the pressure plate, move the pressure plate away from the clutch center to reduce a pushing force for the input-side rotary plates and the output-side rotary plates;
the pressure plate includes pressure-side cam portions including pressure-side slipper cam surfaces to move the pressure plate away from the clutch center to reduce the pushing force for the input-side rotary plates and the output-side rotary plates; and
with the center-side slipper cam surfaces and the pressure-side slipper cam surfaces in contact with each other, at least portions of the pressure-side protrusions overlap with the center-side spline grooves when viewed in the radial direction of the output shaft.

15. The clutch apparatus according to claim 12, further comprising a stopper plate secured to the clutch center to come into contact with the pressure plate and to prevent the pressure plate from moving away from the clutch center in the second direction by a predetermined distance or more; wherein
with the pressure plate and the stopper plate in contact with each other, at least portions of the pressure-side protrusions overlap with the center-side spline grooves when viewed in the radial direction of the output shaft.

16. The clutch apparatus according to claim 12, further comprising a stopper plate secured to the clutch center to come into contact with the pressure plate and to prevent the pressure plate from moving away from the clutch center in the second direction by a predetermined distance or more; wherein
with the pressure plate and the stopper plate in contact with each other, a clearance is created between each of the pressure-side protrusions and the clutch center in the movement direction when viewed in the radial direction of the output shaft; and
a length of the clearance in the movement direction is shorter than a length of each of the output-side rotary plates in the movement direction.

17. The clutch apparatus according to claim 12, further comprising a stopper plate secured to the clutch center to come into contact with the pressure plate and to prevent the pressure plate from moving away from the clutch center in the second direction by a predetermined distance or more; wherein
with the pressure plate and the stopper plate in contact with each other, a clearance is created between each of the pressure-side protrusions and the clutch center in the movement direction when viewed in the radial direction of the output shaft; and
where the output-side rotary plate located farthest in the first direction among those held by the pressure-side fitting teeth, with the pressure plate located closest to the clutch center, is an outermost output-side rotary plate, a surface of the outermost output-side rotary plate facing in the second direction is located in the second direction relative to ends of the pressure-side protrusions facing in the first direction, with the pressure plate and the stopper plate in contact with each other.

18. The clutch apparatus according to claim 12, wherein
the pressure plate includes a housing portion which is recessed in the first direction from the second direction and in which a clutch spring urging the pressure plate in the first direction is housed; and
at least portions of the pressure-side protrusions are located outward of the housing portion in the radial direction.

19. The clutch apparatus according to claim 18, wherein
the pressure-side protrusions are located outward of a radially outer end of the housing portion in the radial direction.

20. The clutch apparatus according to claim 12, wherein
the pressure-side protrusions include a first pressure-side protrusion and a second pressure-side protrusion; and
a length of the first pressure-side protrusion in the movement direction and a length of the second pressure-side protrusion in the movement direction are different from each other.

21. The clutch apparatus according to claim 12, wherein throughout the half-clutch state, at least portions of the pressure-side protrusions overlap with the center-side spline grooves when viewed in the radial direction of the output shaft.

22. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft; and
a pressure plate movable toward or away from the clutch center and configured to hold a remaining one or more output-side rotary plates and to push the input-side rotary plates and the output-side rotary plates; wherein
the clutch center includes:
a center-side outer peripheral wall having an annular shape extending in a movement direction, where a direction in which the pressure plate is movable toward and away from the clutch center is the movement direction; and
center-side fitting teeth holding the output-side rotary plates, protruding outward in a radial direction from an outer peripheral surface of the center-side outer peripheral wall, and arranged in a circumferential direction;
center-side spline grooves each provided between adjacent ones of the center-side fitting teeth; and
center-side cam portions including center-side assist cam surfaces to, upon rotation of the clutch center relative to the pressure plate, produce a force in a direction from the pressure plate toward the clutch center to increase a pushing force for the input-side rotary plates and the output-side rotary plates;
the pressure plate includes:
a pressure-side outer peripheral wall having an annular shape extending in the movement direction;
pressure-side fitting teeth holding the output-side rotary plates, protruding outward in the radial direction from an outer peripheral surface of the pressure-side outer peripheral wall, and arranged in the circumferential direction, pressure-side spline grooves each provided between adjacent ones of the pressure-side fitting teeth; and
pressure-side cam portions including pressure-side assist cam surfaces to, upon rotation of the pressure plate relative to the clutch center, produce a force in the direction from the pressure plate toward the clutch center to increase the pushing force for the input-side rotary plates and the output-side rotary plates;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction;
where a direction in which the pressure plate is movable toward the clutch center is a first direction and a direction in which the pressure plate is movable away from the clutch center is a second direction, an end of the center-side fitting teeth facing in the second direction is provided with center-side protrusions extending in the second direction; and
with the center-side assist cam surfaces and the pressure-side assist cam surfaces in contact with each other, at least portions of the center-side protrusions overlap with the pressure-side spline grooves when viewed in the radial direction of the output shaft.

23. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft; and
a pressure plate movable toward or away from the clutch center and configured to hold the remaining one or more output-side rotary plates and to push the input-side rotary plates and the output-side rotary plates; wherein
the clutch center includes:
a center-side outer peripheral wall having an annular shape extending in a movement direction, where a direction in which the pressure plate is movable toward and away from the clutch center is the movement direction;
center-side fitting teeth holding the output-side rotary plates, protruding outward in a radial direction from an outer peripheral surface of the center-side outer peripheral wall, and arranged in a circumferential direction, center-side spline grooves each provided between adjacent ones of the center-side fitting teeth; and
center-side cam portions including center-side assist cam surfaces to, upon rotation of the clutch center relative to the pressure plate, produce a force in a direction from the pressure plate toward the clutch center to increase a pushing force for the input-side rotary plates and the output-side rotary plates;
the pressure plate includes:
a pressure-side outer peripheral wall having an annular shape extending in the movement direction;
pressure-side fitting teeth holding the output-side rotary plates, protruding outward in the radial direction from an outer peripheral surface of the pressure-side outer peripheral wall, and arranged in the circumferential direction, pressure-side spline grooves each provided between adjacent ones of the pressure-side fitting teeth; and
pressure-side cam portions including pressure-side assist cam surfaces to, upon rotation of the pressure plate relative to the clutch center, produce a force in the direction from the pressure plate toward the clutch center to increase the pushing force for the input-side rotary plates and the output-side rotary plates;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction,
where a direction in which the pressure plate is movable toward the clutch center is a first direction and a direction in which the pressure plate is movable away from the clutch center is a second direction, an end of the pressure-side fitting teeth facing in the first direction is provided with pressure-side protrusions extending in the first direction; and
with the center-side assist cam surfaces and the pressure-side assist cam surfaces in contact with each other, at least portions of the pressure-side protrusions overlap with the center-side spline grooves when viewed in the radial direction of the output shaft.

24. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft;
a pressure plate movable toward or away from the clutch center and configured to hold the remaining one or more output-side rotary plates and to push the input-side rotary plates and the output-side rotary plates; and
a stopper plate secured to the pressure plate to come into contact with the clutch center and to prevent the pressure plate from moving away from the clutch center in a second direction by a predetermined distance or more, where a direction in which the pressure plate is movable toward and away from the clutch center is a movement direction, a direction in which the pressure plate is movable toward the clutch center is a first direction, and a direction in which the pressure plate is movable away from the clutch center is the second direction; wherein
the clutch center includes:
a center-side outer peripheral wall having an annular shape extending in the movement direction; and
center-side fitting teeth holding the output-side rotary plates, protruding outward in a radial direction from an outer peripheral surface of the center-side outer peripheral wall, and arranged in a circumferential direction;
the pressure plate includes:
a pressure-side outer peripheral wall having an annular shape extending in the movement direction; and
pressure-side fitting teeth holding the output-side rotary plates, protruding outward in the radial direction from an outer peripheral surface of the pressure-side outer peripheral wall, and arranged in the circumferential direction;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction;
an end of the center-side fitting teeth facing in the second direction is provided with center-side protrusions extending in the second direction;
with the clutch center and the stopper plate in contact with each other, a clearance is created between each of the center-side protrusions and the pressure plate in the movement direction when viewed in the radial direction of the output shaft; and
a length of the clearance in the movement direction is shorter than a length of each of the output-side rotary plates in the movement direction.

25. A clutch apparatus to transmit a rotational driving force of an input shaft to an output shaft or cut off the rotational driving force, the clutch apparatus comprising:
a clutch center housed in a clutch housing holding input-side rotary plates to be rotationally driven in response to rotational driving of the input shaft, the clutch center holding some of output-side rotary plates positioned alternately with the input-side rotary plates, the clutch center being rotationally drivable together with the output shaft;
a pressure plate movable toward or away from the clutch center and configured to hold a remaining one or more output-side rotary plates and to push the input-side rotary plates and the output-side rotary plates; and
a stopper plate secured to the clutch center to come into contact with the pressure plate and to prevent the pressure plate from moving away from the clutch center in a second direction by a predetermined distance or more, where a direction in which the pressure plate is movable toward and away from the clutch center is a movement direction, a direction in which the pressure plate is movable toward the clutch center is a first direction, and a direction in which the pressure plate is movable away from the clutch center is the second direction; wherein
the clutch center includes:
a center-side outer peripheral wall having an annular shape extending in the movement direction; and
center-side fitting teeth holding the output-side rotary plates, protruding outward in a radial direction from an outer peripheral surface of the center-side outer peripheral wall, and arranged in a circumferential direction;
the pressure plate includes:
a pressure-side outer peripheral wall having an annular shape extending in the movement direction; and
pressure-side fitting teeth holding the output-side rotary plates, protruding outward in the radial direction from an outer peripheral surface of the pressure-side outer peripheral wall, and arranged in the circumferential direction;
when viewed in an axial direction of the output shaft, a center-side annular portion at least partially overlaps with a pressure-side annular portion, the center-side annular portion having an annular shape bounded in the radial direction by a center-side tooth tip circle passing through tooth tips that are outermost portions of the center-side fitting teeth in the radial direction, and a center-side tooth bottom circle passing through tooth bottoms that are innermost portions of the center-side fitting teeth in the radial direction, the pressure-side annular portion having an annular shape bounded in the radial direction by a pressure-side tooth tip circle passing through tooth tips that are outermost portions of the pressure-side fitting teeth in the radial direction, and a pressure-side tooth bottom circle passing through tooth bottoms that are innermost portions of the pressure-side fitting teeth in the radial direction;
an end of the pressure-side fitting teeth facing in the first direction is provided with pressure-side protrusions extending in the first direction;
with the pressure plate and the stopper plate in contact with each other, a clearance is created between each of the pressure-side protrusions and the clutch center in the movement direction when viewed in the radial direction of the output shaft; and
a length of the clearance in the movement direction is shorter than a length of each of the output-side rotary plates in the movement direction.
